(19) United States
(12) Patent Application Publication
(10) Pub. No.: US 2026/0326938 A1
(43) Pub. Date: Oct. 22, 2026

(54) AERIAL MARINE DRONE SYSTEM AND METHOD

(71) Applicant: Omar F. Guerra Johansson, Fort Lauderdale, FL (US)

(72) Inventor: Omar F. Guerra Johansson, Fort Lauderdale, FL (US)

(21) Appl. No.: 19/248,039

(22) Filed: Jun. 24, 2025

Related U.S. Application Data
(63) Continuation-in-part of application No. 17/833,488, filed on Jun. 6, 2022, now Pat. No. 12,372,408.
(60) Provisional application No. 63/197,373, filed on Jun. 5, 2021.
(60) Provisional application No. 63/232,570, filed on Aug. 12, 2021.

(51) Int. Cl. B64U 80/84; B64U 10/14; B64U 10/60; B64U 80/70; B64U 101/30; B64U 101/55; G05D 1/686; G05D 105/80; G05D 107/00; G05D 109/25

(52) U.S. Cl. CPC B64U 80/84; B64U 10/14; B64U 10/60; B64U 80/70; G05D 1/686; B64U 2101/30; B64U 2101/55; G05D 2105/80; G05D 2107/25; G05D 2109/254

(57) ABSTRACT

A marine drone system utilizing an unmanned aerial vehicle (UAV) to provide visual feedback and situational awareness for marine conditions, including indicators of favorable fishing activity such as weed lines, flotsam, water breaks, birds, or fish. The system employs a plurality of sensors including cameras, infrared imaging, laser, GPS, radar, and LIDAR. Video and sensor outputs are transmitted to a control module with a graphic user interface (GUI), which displays map or video backgrounds with interactive overlays. Operational modes include Follow Mode and Sense Mode, and selectable sub-modes such as Fish-On, Family Fun, and Man Overboard, each initiated via the GUI. System hardware includes the UAV, a base station with power supply, and a tether providing electrical power and bi-directional data communication. The invention includes methods for detecting, tracking, and displaying real-time environmental data, enhancing safety, navigation, and recreational marine activities through integrated aerial observation and user control.

### CROSS-REFERENCE TO RELATED APPLICATIONS

This application is a continuation-in-part of co-pending patent application Ser. No. 17/833,488, filed Jun. 6, 2022, entitled, “AERIAL MARINE DRONE SYSTEM AND METHOD”, which claims the benefit or priority under 35 USC 119(e) of provisional patent application Ser. No. 63/197,373 filed Jun. 5, 2021, and provisional patent application Ser. No. 63/232,570 filed Aug. 12, 2021, all of which is incorporated by reference in its entirety.

### FIELD OF INVENTION

The invention generally relates to unmanned aerial vehicles and associated control software used in marine applications.

### BACKGROUND

In the maritime environment, situational awareness is critical for safety, navigation, recreation, and operational decision-making. Traditionally, visual awareness aboard marine vessels have been limited to the line of sight available to crew members and to fixed onboard equipment such as mast-mounted cameras or radar. Sport fishing boats have often relied on tuna towers to achieve an elevated visual vantage point, enabling observation of water conditions or detection of fish-related activity. However, tuna towers present several drawbacks: they are typically confined to larger vessels, may be inaccessible to individuals with limited mobility, and introduce height and stability concerns.

With the increasing availability of Unmanned Aerial Vehicles (UAVs), new opportunities have emerged to augment a vessel's visual perspective beyond conventional means. However, conventional drones are often unsuited to marine environments. They typically rely on limited battery life, lack robust navigation integration with dynamic marine vessels, and require manual piloting, which is challenging aboard a moving platform.

In my previous application, I disclosed a marine drone system that provided an aerial perspective for fishing-related use cases via a tethered unmanned aerial vehicle (UAV) coupled with a control module having a graphical user interface. That system allowed users to receive and interact with high-definition video feeds, water temperature outputs from an infrared sensor, water depth information from a LIDAR sensor, and object detection data via radar. The interface was capable of displaying layered visual data, including overlays of sensor data on video or map feeds, and allowed the user to interact with on-screen targets for labeling, distance measurement, and tracking. A key objective of that invention was to emulate the functionality of a tuna tower without requiring a physical structure, effectively creating a “virtual tuna tower” for fishing.

The present invention disclosed herewith builds upon and significantly expands the scope of that earlier marine drone system. While the prior system was primarily focused on enhancing fishing capabilities, the improved invention now addresses a broader set of maritime needs including navigation, safety, family recreation, and environmental monitoring. It leverages advancements in UAV autonomy, sensor fusion, and video-based control to deliver a robust aerial videography and data collection system that is fully integrated with a marine vessel.

In particular, the current invention presented in this disclosure introduce new operational modes that extend the functionality of the system. Navigation Mode assists captains in docking and piloting by providing a high-elevation video feed-oriented forward of the vessel. Search and Rescue (SAR) Mode enables dynamic tracking of man-overboard incidents, automatically logging coordinates and maintaining persistent visual contact with the victim to support coordinated recovery. Sentry Mode provides continuous aerial surveillance of individuals swimming or recreating near the vessel, offering an added layer of safety and oversight. Fish-On Mode records fishing events from an elevated vantage point, providing geotagged video documentation of catches and the surrounding conditions. Autonomous Follow-Me Mode allows the UAV to maintain a fixed position and heading above the vessel in real-time, even during vessel movement, through the use of sensor fusion and multi-modal localization technologies. Data Collection Mode captures environmental and operational telemetry, storing it onboard and uploading it for post-mission review, analytics, or compliance tracking.

These expanded capabilities disclosed in this application are enabled by the integration of multiple sensing modalities, including GPS (with RTK/PPK), Ultra-Wideband (UWB) positioning, LIDAR, RADAR, and visual markers. Advanced control and perception software running on an onboard companion computer interprets this data using sensor fusion algorithms such as the Unscented Kalman Filter (UKF) to achieve precise positioning and reliable operation under dynamic and adverse maritime conditions. Moreover, the system includes autonomous launch and recovery functionality (HDAL/HDAR), eliminating the need for manual piloting during takeoff or landing, and making the system accessible to users without UAV flight expertise.

Thus, the present invention represents a natural evolution of the previously disclosed system, transforming it from a fishing aid into a multi-role, intelligent aerial support platform for marine vessels. It retains and enhances the core functional elements of visual monitoring and interactive data display, while introducing novel capabilities that significantly broaden its applicability across safety, navigation, recreation, and data analytics in maritime environments.

### SUMMARY

The invention provides a marine drone system and associated methods and electronic devices for performing autonomous tracking, sensing, and video streaming operations. The system includes an unmanned aerial vehicle (UAV) coupled to a control module with a display and graphical user interface (GUI), where the control module includes a processor and memory configured to execute stored instructions.

The instructions enable the UAV to initiate a hover mode of flight and operate in at least two selectable modes: a follow mode and a sense mode. In follow mode, the system obtains video from a PTZ camera and initiates a tracking function that follows a watercraft and displays real-time video on the GUI. The follow mode further includes multiple sub-modes, including, but not limited to a Fish-On mode (tracking the stern of the boat and recording fishing activity), a Family Fun mode (locking the camera onto a predefined geographic location), and a Man Overboard mode (locking onto and tracking a person in water during rescue operations). Each of these sub-modes can be selected by user interaction with the GUI.

In sense mode, the system offers functions for monitoring water depth, detecting objects, and streaming video, using sensors such as LIDAR, radar, and the PTZ camera. Outputs from both follow and sense modes may be displayed as overlays on background layers such as maps or live camera feeds. The GUI further supports user interaction to select displayed objects, label them, and initiate distance-measurement functions using laser pulses and onboard sensors including gyroscope, accelerometer, and GPS.

Interactive GUI locations allow the user to view video feeds, depth data, and object detection information. Tapping specific GUI locations triggers context-specific outputs, such as video from the Fish-On, Family Fun, or Man Overboard modes.

In some embodiments, the invention further includes a tethered UAV system in which the UAV is physically connected to a mountable container via a tether that includes electrical supply and data wiring, enabling power delivery and bi-directional communication. The system may include a waterproof UAV body with multiple onboard sensors, propellers, and a laser for environmental measurement and location identification. The control module may further include networking capability to upload environmental or fishing-related data.

It is an objective of the invention to provide a marine drone system that enhances navigational awareness by autonomously delivering a live, elevated video feed of the vessel's surroundings to assist in piloting, docking, and obstacle avoidance.

It is another objective of the invention to improve maritime safety through a Search and Rescue (SAR) mode that enables persistent visual tracking and geolocation of persons who have fallen overboard, even as the vessel is in motion.

It is yet another objective of the invention to provide autonomous UAV tracking of the vessel using sensor fusion and multi-modal localization, allowing the UAV to maintain stable flight and video capture over a moving vessel without manual control.

It is a further objective of the invention to enable automated takeoff, landing, and recovery of the UAV from a dynamically moving vessel, thereby reducing reliance on manual piloting and increasing operational reliability.

It is also an objective of the invention to provide a recreational videography tool through configurable modes such as Fish-On Mode and Sentry Mode, allowing users to document events and monitor guests engaging in water-based activities near the vessel.

Another objective of the invention is to facilitate structured environmental and operational data collection, with onboard storage and automated upload capabilities, supporting post-mission analysis, system diagnostics, and regulatory compliance.

The drawings and specific descriptions of the drawings, as well as any specific or alternative embodiments discussed, are intended to be read in conjunction with the entirety of this disclosure. The invention may be embodied in many different forms and should not be construed as being limited to the embodiments set forth herein; rather, these embodiments are provided by way of illustration only and so that this disclosure will be thorough, complete and fully convey understanding to those skilled in the art. The above and yet other objects and advantages of the present invention will become apparent from the hereinafter set forth Brief Description of the Drawings, Detailed Description of the Invention, and Claims appended herewith.

### BRIEF DESCRIPTION OF THE DRAWINGS

FIG. 1 is a conceptual view of the aerial marine drone system in operation.

FIG. 2 is an isometric view of the drone housed in the container of the aerial marine drone system.

FIG. 3 is an exploded isometric view of the aerial marine drone system illustrated in FIG. 2.

FIG. 4 is a front perspective view of the unmanned aerial vehicle of the aerial marine drone system.

FIG. 5 is an isolated perspective cut-away view of the internal components of the unmanned aerial vehicle of the aerial marine drone system.

FIG. 6 is a schematic view of the unmanned aerial vehicle of the aerial marine drone system.

FIG. 7 is a schematic view of the container of the aerial marine drone system.

FIG. 8 is a flow diagram of a functional aspect of the aerial marine drone system.

FIG. 9 is a screen layout of a graphic user interface illustrating functionality with a video feed background.

FIG. 10 is a screen layout of a graphic user interface illustrating functionality with a depth information background.

FIG. 11 is a screen layout of a graphic user interface illustrating functionality with a temperature gradient background.

FIG. 12 is a screen layout of a graphic user interface illustrating functionality with expanded menu displayed.

FIG. 13 is a screen layout of a graphic user interface illustrating functionality including interactive tapping, tap interaction menu, and flight data.

FIG. 14 is a flow diagram of a functional aspect of the aerial marine drone system with enhanced visual tracking functionality.

FIG. 15 is a screen layout of a graphic user interface illustrating On Deck mode.

FIG. 16 is a screen layout of a graphic user interface illustrating Navigation mode.

FIG. 17 is a screen layout of a graphic user interface illustrating Fishing mode.

FIG. 18 is a screen layout of a graphic user interface illustrating Fish-On mode.

FIG. 19 is a screen layout of a graphic user interface illustrating Family mode.

FIG. 20 is a screen layout of a graphic user interface illustrating Man Overboard mode at a bird's eye view.

FIG. 21 is a screen layout of a graphic user interface illustrating Man Overboard mode focused on the overboard individual.

FIG. 22 is a screen layout of a graphic user interface illustrating an initial phase of Recovery mode as the UAV is in the air.

FIG. 23 is a screen layout of a graphic user interface illustrating a later phase of Recovery mode as the UAV approaches its landing location.

FIG. 24 is a screen layout of a graphic user interface illustrating an initial phase of Emergency Recovery mode as the UAV is in the air.

### DETAILED DESCRIPTION OF THE INVENTION

The present invention provides an advance solution for visual tracking and applications in marine environmental conditions requiring an altitude higher than a marine craft. The solution includes a container configured to be mountable on an upper surface of a watercraft, wherein the container further includes a means of supplying power. The system also includes an unmanned aerial vehicle having a weather-proof and water-proof casing, a plurality of sensors coupled to the unmanned aerial vehicle, including at least one camera, at least one radar module, at least one LIDAR module, at least one GPS module, and a plurality of propellers capable of lifting the unmanned aerial vehicle and supporting the weight of the unmanned aerial vehicle and a tether. Some embodiments also include at least one bathymetric sensor, and/or temperature/IR sensor, and/or at least one laser module. Many of the sensors and various instruments (video, IR, etc.) will detect objects (fish/fisherman, overboard guests, etc.,) and the laser will be used to detect the location and return this information in the form of a GPS coordinate location, which may be displayed by the system.

The system includes a tether, wherein the tether includes electrical supply wiring and data wiring. The tether couples the unmanned aerial vehicle to the container, wherein the tether supplies the unmanned aerial vehicle with power through the electrical supply wiring, and provides for a bi-directional communication link through the data wiring. The system includes a control module having an interactive graphic user interface, configured to execute a program configured to show a video output, show a visual radar output, show a visual LIDAR output, show a GPS location of the unmanned aerial vehicle, and show a GPS location of the graphic user interface. The control module includes a means for relaying information between the unmanned aerial vehicle and the interactive graphic user interface and the control module including a network uplink for uploading identification information on various conditions.

More particularly, this disclosure relates to enhancements over my previous system. Namely, this disclosure provides a UAV with an aerial videography system for maritime applications using a small-type flying vehicle equipped with an onboard camera for videography. In recent years, with the advancement of UAVs, cameras for video recording and surveying have been installed on UAVs, enabling aerial videography. For certain applications, the UAV utilizes a wired power source (tether) to maintain system availability for extended periods and avoid limitations imposed by the onboard UAV battery.

Marine vessels require real-time visual images of their surroundings for various purposes. These visual feeds often need to capture images of objects located both near the vessel and far into the horizon. Utilizing a video camera at a high elevation onboard a UAV provides the end user with a comprehensive view of the immediate surroundings of the vessel, as well as zoom capabilities to clearly visualize distant objects. This video feed is displayed on a programmable UAV controller equipped with intelligent functions for the user. The video feed is displayed on a smart controller onboard the vessel. This controller is a programmable device that sends pre-programmed commands to the UAV and provides a high-definition display for viewing the video feed from the UAV's camera. The programmable controller is responsible for running and executing the following additional and enhanced services: Navigation Mode, Search and Rescue (SAR) Mode, Family Fun (Sentry Mode), Fish On Mode, Data Collection Mode, Autonomous UAV Follow-Me Mode, Sensing and Localization Mode. The enhancements also include additional enhancements to sensors and the inclusion of additional sensors, such as: enhanced Global Positioning System (GPS) and Ultra-Wideband (UWB) equipment.

Navigation mode allows the captain to toggle between navigational maps and a live video feed. When viewing the video feed, the captain obtains a live video feed from the UAV, viewing the vessel from an elevation of 50 feet or higher above the deck. The UAV's camera is tilted downwards at a negative 30-degree angle, providing a wide-angle view of the area ahead of the vessel. The smart interface on the controller allows the captain to tilt and turn the UAV's camera to observe what lies ahead as the vessel approaches its destination. This is particularly useful when approaching a docking location, as the captain can maintain full situational awareness of the vessel's surroundings to navigate into the designated slip.

The software autonomously flies the UAV to a pre-designated altitude, angles its camera downwards, switches to a wide-angle lens, and displays the aforementioned video feed. Concurrently, the invention's software controls the UAV to fly above the vessel and match its heading and speed while maintaining the pre-designated altitude. The controller continuously displays the UAV's heading and altitude. Additionally, a video recording feature is provided to memorialize the event if desired by the captain. Once the captain has achieved their navigation goal, they can exit “Navigation” mode on the controller, and the UAV will return to the minimum pre-designated altitude, match the vessel's heading, and tilt the camera forward, placing the UAV in “Standby Mode.”

Search and Rescue (SAR) mode facilitates finding and rescuing individuals who may have fallen overboard. The invention dynamically follows with the UAV camera while matching the vessel's speed and heading to remain above it at all times. In this mode, the captain obtains a live video feed from the UAV, viewing the vessel from an elevation of 50 feet or a pre-designated higher altitude above the deck. The UAV's camera is tilted downwards at a negative 60-degree angle while turning the UAV towards the rear of the vessel, providing a wide-angle view of the area astern. The smart interface on the controller allows the captain to zoom, tilt, and turn the UAV's camera in any direction to search behind the vessel. The interface allows the user to “mark” a Man Overboard position by pressing the controller's touchscreen and labeling the “victim.” The UAV continues to match the vessel's heading and speed while dynamically tilting and zooming the onboard camera to effectively track the victim's position in the water. The smart controller provides a video feed of the victim and the approximate GPS coordinates of the fallen person. This GPS location is dynamically updated and calculated using the vessel's current position and the estimated location based on the initial optical tag created by the user. This invention allows the captain to maintain a high-altitude view of the victim's location despite the vessel's movement.

Additionally, the system can share the victim's location with other devices capable of receiving predefined data packets over the vessel's Local Area Network. This location information can be used by other UAVs to assist in the rescue. Similar to Navigation Mode, this feature is useful when approaching the victim's location and provides the captain with complete situational awareness of both the vessel and the victim during the entire rescue operation.

In this mode, the system automatically records the SAR event to the controller's digital storage unit. Once the rescue is complete, the captain can exit “SAR” mode on the controller, and the UAV will return to the minimum pre-designated altitude, match the vessel's heading, and tilt the camera forward, returning to “Standby Mode.”

Family Fun (Sentry Mode) allows the captain to obtain a live video feed from the UAV, viewing forward ahead of the vessel from an altitude of 50 feet or any pre-designated height. The UAV's camera is tilted downwards at a negative 30-degree angle, providing a wide-angle view of the area ahead of the vessel. The smart interface on the controller provides the captain with options to zoom, tilt, and turn the UAV's camera in any direction. The interface allows the user to “mark” a point on the screen, locking the camera onto the designated surveillance target. The UAV continues to match the vessel's heading and speed while dynamically tilting and zooming the onboard camera to effectively track the target and keep it in view. The smart controller provides a video feed of the target and its approximate GPS coordinates. Video recording is enabled to memorialize the event.

This system allows the captain to maintain a high-altitude view of a specific object despite the vessel's movement. This feature provides the captain with complete situational awareness of the vessel and its guests while swimming or engaging in activities near the shore. Upon achieving the surveillance goal, the captain can exit “Sentry Mode” on the controller, and the UAV will return to the minimum pre-designated altitude, match the vessel's heading, and tilt the camera forward, returning to “Standby Mode.”

Fish-On Mode is designed to record the capture of fish onboard the vessel. When a crew member announces “Fish-On,” the captain activates the “FISH ON” feature by selecting a pre-designated icon on the smart controller. The controller provides a live video feed from the UAV, viewing the vessel from 50 feet or a pre-designated higher altitude above the deck. The UAV's camera is tilted downwards at a negative 60-degree angle while turning towards the rear of the vessel, providing a wide-angle view of the area astern.

The smart interface on the controller provides the captain with zoom, tilt, and turn options for the UAV's camera to capture the fishing action at the rear of the vessel. The interface allows the user to “lock” the camera in a specific position. The UAV continues to match the vessel's heading and speed while dynamically tilting and zooming the onboard camera to effectively record the fishing action.

The smart controller provides a video feed and the approximate GPS coordinates of where the “FISH ON” feature was initially activated, providing users with the exact location of their catch. All captured video can be downloaded from the smart controller for electronic sharing. After achieving the “Fish On” goal, the captain can exit this feature on the controller, and the UAV will return to the minimum pre-designated altitude, match the vessel's heading, and tilt the camera forward, returning to “Standby Mode.”

A Data Collection feature enables the UAV to record all events in a structured database that can be accessed offline. The invention maintains continuous records of time, date, UAV GPS coordinates, vessel speed, vessel heading, UAV altitude, UAV temperature, UAV speed, wind speed, UAV relative heading in relation to the vessel, UAV absolute heading, camera heading, camera angle, UAV mode (Fishing, Navigation, etc.), MOB tracking locations from activation to deactivation, and “FISH ON” GPS coordinates from activation to deactivation. Additionally, the UAV records all flight data saved by the UAV's autopilot. Once the UAV has landed and is disarmed, the system enters maintenance mode and attempts to connect to the internet using the onboard local area network. Upon establishing a connection, the invention uploads all collected data to a pre-designated cloud server for future analysis. Furthermore, the UAV attempts to upload all video stored on the smart controller to a pre-designated cloud archive server.

The system provides an Autonomous UAV Follow-Me Mode. The increasing demand for autonomous capabilities in various domains extends to maritime operations, where unmanned aerial vehicles (UAVs) can provide invaluable support for surveillance, monitoring, logistics, and data collection. A significant challenge in this context is enabling a UAV to autonomously follow a moving vessel, maintaining a stable relative position despite the vessel's dynamic motion, environmental disturbances, and potential GPS signal degradation. This disclosure outlines an autonomous UAV solution designed to address this challenge, leveraging a sophisticated fusion of advanced sensing technologies and a distributed computational architecture involving both on-board UAV systems and a powerful companion computer. The primary objective of this solution is to ensure robust and precise relative positioning and attitude control of the UAV with respect to the target vessel. This requires real-time perception of the vessel's state (position, velocity, orientation) and the surrounding environment, coupled with intelligent control algorithms that can adapt to dynamic changes. The system prioritizes reliability, redundancy, and resilience against various operational challenges, including adverse weather conditions and GPS-denied environments.

In addition to the technologies disclosed in my earlier patent application, there are several key technologies employed for the autonomous UAV Follow-Me Mode. This mode utilizes the sensing and localization technologies described in the “Sensing and Localization” section below, including GPS, UWB, LIDAR, RADAR, and Visual Fiduciary Markers.

The system comprises a multi-rotor UAV equipped with a suite of sensors and an embedded flight control system. A dedicated companion computer, integrated with the UAV, handles computationally intensive tasks such as advanced perception, sensor fusion, and high-level mission planning. The target vessel is outfitted with passive and active markers to facilitate accurate tracking. A ground control station (GCS) provides video monitoring, mission oversight, and intervention capabilities.

For sensing and localizing, accurate and robust localization of the UAV relative to the vessel is paramount. This system employs a multi-modal sensor approach to achieve high precision and redundancy, mitigating the limitations of individual sensor technologies.

GPS provides the UAV's absolute global position, serving as the primary source for coarse navigation and initial positioning. It is crucial for long-range transit to the vessel's vicinity and for maintaining general situational awareness. The UAV is equipped with a multi-constellation GNSS receiver. To overcome the inherent accuracy limitations of standard GPS (typically meters), the system incorporates RTK (Real-Time Kinematic) or PPK (Post-Processed Kinematic) GPS.

Regarding RTK/PPK Principles, by measuring the phase of the satellite signals and transmitting correction data, the UAV's position can be determined with centimeter-level accuracy (<5 cm).

UWB technology is critical for high-precision, low-latency relative positioning between the UAV and the vessel, especially effective in GPS-denied or degraded environments. UWB systems measure the Time-of-Flight (ToF) of radio signals between transceivers. By deploying multiple UWB “anchors” on the vessel and a UWB “tag” on the UAV, the precise distances (ranges) to these anchors can be determined. Trilateration or multilateration algorithms then compute the UAV's 3D position relative to the vessel.

Implementation on a vessel side includes four UWB anchors are strategically placed on the vessel's deck, forming a known geometric configuration. Their positions are precisely surveyed relative to the vessel's center of mass. Implementation on a UAV side includes a single UWB tag is mounted on the UAV.

One advantage is a high accuracy of centimeter-level ranging accuracy (<10 cm). Another advantage is a high update rate, typically hundreds of Hz, providing real-time position updates. A further advantage is robustness, as it is less susceptible to multi-path interference compared to narrowband radio technologies.

There is a line-of-sight (LoS) requirement. While UWB performs well, maintaining LoS between the UAV tag and vessel anchors is crucial for optimal performance.

Another equipment is the Light Detection and Ranging (LIDAR) device integration. LIDAR provides detailed 3D point cloud data of the environment, enabling precise relative pose estimation of the vessel, obstacle avoidance, and local environment mapping. LIDAR sensors emit laser pulses and measure the time it takes for these pulses to return after reflecting off objects. This allows for the creation of a dense 3D representation of the surroundings. The system implements Solid-State LIDAR. Solid-state LIDARs offer smaller form factors and lower cost, suitable for direct vessel-relative pose estimation.

Data processing on a companion computer is also implemented. The system utilizes iterative point cloud registration algorithms, such as Iterative Closest Point (ICP), to align successive LIDAR scans and register the UAV's real-time point cloud with a pre-scanned or dynamically generated 3D model of the target vessel. This alignment facilitates accurate calculation of the UAV's relative position and orientation with respect to the vessel. Additionally, the companion computer performs real-time obstacle detection and avoidance by processing incoming LIDAR data to identify environmental features, such as waves, vessel structures, or nearby objects. This enables the UAV to execute collision-avoidance maneuvers and maintain safe operation during autonomous navigation and landing sequences.

The system further incorporates Radio Detection and Ranging (RADAR) technology to supplement environmental sensing and enhance operational robustness under adverse conditions. RADAR provides reliable long-range object detection by emitting radio waves and measuring the reflected signals to determine the distance, velocity, and angular position of surrounding objects. This modality is particularly valuable in fog, heavy rain, or low-visibility environments where optical or LIDAR systems may become unreliable. The UAV is equipped with a forward-looking millimeter-wave (mmWave) radar sensor, which offers high resolution in a compact form factor well-suited to aerial applications. Optionally, passive radar reflectors may be installed on the vessel to improve the radar cross-section and facilitate more consistent detection. RADAR contributes several operational advantages, including the ability to penetrate atmospheric obstructions, detect objects at longer ranges than LIDAR, and directly measure relative velocity using Doppler-based calculations. These capabilities support both situational awareness and collision avoidance during autonomous flight operations.

The system further includes a visual pose estimation capability using Visual Fiduciary Markers affixed to the vessel. These markers provide a highly accurate, short-range method for determining the relative position and orientation (pose) of the UAV with respect to the vessel. The system employs high-contrast, uniquely identifiable patterns, which are placed at known, surveyed locations on the vessel's deck. These patterns serve as reference points that can be detected and interpreted by the UAV's onboard vision system.

The UAV is equipped with a downward-facing, high-resolution RGB camera with a wide field of view. This camera continuously captures images of the deck area as the UAV operates above the vessel. To ensure consistent marker detection under various lighting conditions, including glare, shadow, or low-light scenarios, the camera system incorporates an integrated illumination subsystem, such as infrared (IR) LEDs. The image data is processed in real time by a companion computer onboard the UAV.

The vision system employs high-frame-rate image acquisition and leverages robust marker detection and decoding algorithms. These may include computer vision libraries such as OpenCV, and specifically dedicated algorithms such as those used for ArUco-style markers. Upon detection, the system extracts corner coordinates of the marker patterns and calculates the 3D pose of the camera relative to each marker using perspective-n-point (PnP) techniques. Because the markers have known physical dimensions and fixed spatial relationships to one another, the system can triangulate the UAV's position and orientation with sub-centimeter accuracy.

By combining pose estimates from multiple simultaneously visible markers, and referencing their known configuration on the vessel, the companion computer generates a highly accurate, real-time estimate of the vessel's six degrees-of-freedom (6-DOF) pose relative to the UAV. This information is used to maintain flight stability, facilitate precise hover and navigation control, and enable reliable autonomous launch and recovery functions.

The use of Visual Fiduciary Markers presents several operational advantages. These markers are entirely passive and require no power, reducing system complexity and points of failure. They provide direct and interpretable position and orientation estimates, rather than requiring derived or inferred data. Furthermore, the markers can encode unique identifiers, allowing the UAV to confirm it is tracking the correct vessel, even in environments with multiple marked targets. This capability is critical for maintaining vessel-specific operational fidelity in scenarios involving fleet operations, multi-vessel proximity, or search and rescue deployments.

Landing an unmanned aerial vehicle (UAV) onto a moving marine vessel has traditionally required the skill and constant attention of a trained human pilot. The operator must visually assess the UAV's flight condition and manually guide it to a landing platform, compensating in real time for vessel movement, wind, and other environmental disturbances. These conditions make UAV recovery aboard a moving vessel a complex and error-prone procedure, especially in high sea states or limited visibility.

The present invention eliminates the dependency on manual piloting by introducing a Highly Dynamic Autonomous Recovery (HDAR) system. HDAR enables the UAV to autonomously land on the deck of a vessel in motion by using a network of integrated sensors, localization mechanisms, and a programmable control system. The UAV, in combination with its onboard computing and perception subsystems, executes the recovery sequence with high precision and without operator input. This significantly enhances operational safety, reliability, and accessibility for users who may lack specialized piloting skills.

The HDAR mode relies on multiple sensing and localization modalities to achieve accurate pose estimation and stable control during recovery. The system integrates Global Positioning System (GPS), Ultra-Wideband (UWB) ranging, Light Detection and Ranging (LIDAR), Radio Detection and Ranging (RADAR), and Visual Fiduciary Markers. These sensors provide complementary data sources, enabling the system to compensate for the limitations of any single modality and ensuring redundancy in complex or degraded environments.

The UAV itself is a multi-rotor aircraft equipped with a suite of embedded sensors and a flight control system. A companion computer is mounted onboard the UAV to handle real-time processing demands. This includes advanced perception algorithms, sensor fusion, and execution of autonomous guidance routines. The companion computer aggregates data from the sensing systems and performs continuous estimation of the UAV's position, orientation, and velocity relative to the moving vessel.

On the vessel side, passive and active markers are deployed to facilitate precision tracking during the approach and landing phase. The ground control station (GCS) monitors the UAV's progress and provides high-level mission oversight, including fallback options or emergency interventions. The combination of real-time sensor fusion and trajectory planning allows the UAV to dynamically adapt to changing vessel motion, wind conditions, and spatial constraints, thereby achieving a controlled descent and precise touchdown on the vessel deck.

The Highly Dynamic Autonomous Launch (HDAL) system enables the UAV to initiate flight operations without requiring manual piloting or intervention. Traditional UAV launches aboard marine vessels are subject to a number of operational challenges, including confined spaces, deck instability, wind variability, and the need for skilled human control. The HDAL system addresses these challenges by transforming the UAV into a fully autonomous robotic platform capable of safely launching itself from the vessel under varying environmental and operational conditions.

By removing the requirement for a human pilot during launch, the system delivers a range of operational benefits. These include improved efficiency through rapid deployment, reduced likelihood of pilot error, increased accessibility for users with no UAV flight training, and enhanced safety by minimizing risk to personnel during takeoff. Furthermore, the system offers consistent and repeatable launch behavior, allowing for standardized procedures and reduced operational variability.

The autonomous launch sequence is executed using a multi-modal sensing framework that includes Global Positioning System (GPS), Ultra-Wideband (UWB) ranging, Light Detection and Ranging (LIDAR), Radio Detection and Ranging (RADAR), and Visual Fiduciary Markers. These technologies operate in concert to provide the UAV with a detailed understanding of its position and orientation relative to the vessel and surrounding environment. The system's reliance on redundant and complementary sensing inputs enhances robustness under conditions of degraded visibility, electromagnetic interference, or signal loss.

The UAV is equipped with an embedded flight controller and a dedicated companion computer responsible for real-time processing. The companion computer handles computationally intensive tasks such as environment perception, sensor data fusion, state estimation, and trajectory planning. Launch operations are managed through a ground control station (GCS), which provides interface functionality, mission initiation, and monitoring capabilities. However, the launch sequence itself is autonomous, requiring only user confirmation to begin.

To execute a launch, the UAV initializes its sensing and control systems, assesses current environmental conditions, and begins a controlled ascent from the vessel deck. During this process, it continuously tracks its own state relative to the vessel using the aforementioned sensor suite. Once airborne, the UAV transitions into its assigned mission mode, such as station-keeping, follow-me tracking, or video surveillance, without the need for manual input. This seamless integration of autonomous launch into the broader operational framework of the UAV system enhances mission readiness and system utility in a range of maritime scenarios.

To maintain accurate and reliable control of the UAV in a dynamic maritime environment, the system employs a sensor fusion module that integrates data from multiple onboard and vessel-based sensors. These include Global Positioning System (GPS), Ultra-Wideband (UWB) ranging systems, Light Detection and Ranging (LIDAR), Radio Detection and Ranging (RADAR), and optical vision systems such as Visual Fiduciary Markers. The purpose of this fusion process is to generate a continuous, real-time estimate of the UAV's position, velocity, and orientation both globally and relative to the host vessel.

The core of the fusion system resides in a high-performance onboard computer, which executes a non-linear state estimation algorithm known as the Unscented Kalman Filter (UKF). The UKF is specifically suited to handle the nonlinear dynamics and sensor characteristics associated with UAV operations. It functions by predicting the UAV's state based on a dynamic model and then updating that prediction in response to incoming sensor data. Each sensor's contribution is weighted according to its estimated uncertainty, allowing the system to adapt dynamically to changing environmental conditions and sensor performance.

Data prioritization is a key feature of the fusion engine. In close-proximity operations, such as hovering above the vessel or performing landing maneuvers, the system relies primarily on UWB and visual marker inputs to determine fine-grained relative positioning. These sensors provide superior spatial resolution and temporal stability in constrained or cluttered environments. For broader context and initial acquisition, GPS serves as the global positioning backbone. Meanwhile, LIDAR and RADAR contribute to obstacle detection and local environment mapping, enhancing operational safety and route planning.

By synthesizing data across these varied sensor modalities, the fusion module provides the UAV's flight controller and mission planner with a robust and resilient situational model. This enables precision flight control, adaptive trajectory planning, and safe autonomous operation under a wide range of operating conditions, including degraded GPS environments, visual occlusion, and variable sea states.

The UAV operates using a layered, modular software architecture designed to manage all onboard functions autonomously and in real time. This onboard software stack includes subsystems for flight control, perception, health monitoring, and high-level control logic. Each component is optimized to fulfill its respective role in maintaining stable and intelligent UAV behavior during maritime operations.

At the foundation of the software stack is the flight controller (FC) firmware, which integrates inertial measurement unit (IMU) data from accelerometers, gyroscopes, and magnetometers to estimate the UAV's current attitude, including roll, pitch, yaw, and angular velocities. The FC employs Proportional-Integral-Derivative (PID) control loops to maintain stability, manage altitude hold, and achieve precise position control. Additionally, the flight controller generates pulse-width modulation (PWM) signals that directly drive the UAV's motors, translating control inputs into physical thrust. It also interfaces with fundamental onboard sensors, including barometric altimeters, airspeed sensors, and baseline GPS units, to support basic navigational and control functions.

Above the flight control layer, a lightweight perception module is implemented to handle local environmental sensing. This module processes data from short-range proximity sensors, such as LIDAR, to detect and avoid immediate obstacles. It enables reactive collision avoidance maneuvers without the need for high-latency offboard processing, which is particularly important during takeoff, landing, or operation in cluttered marine environments.

The UAV also includes a health monitoring subsystem that continuously evaluates critical operating parameters. This includes battery voltage levels, motor temperatures, and overall system integrity. By monitoring these values in real time, the system can alert the operator or initiate predefined safety behaviors in the event of degraded performance or impending failure.

At the top of the onboard software stack lies the high-level control module, which acts as an interface between the companion computer and the flight controller. This module receives position and velocity commands from the companion computer, typically derived from mission planning or sensor fusion outputs, and translates them into specific attitude and thrust instructions executable by the flight controller. The high-level controller also includes advanced disturbance rejection techniques, such as Model Predictive Control (MPC), to maintain stable flight in the presence of external disturbances like wind gusts or unpredictable vessel movement.

The UAV is equipped with a high-performance embedded companion computer that serves as the primary computational hub for mission-critical processing tasks. This companion computer incorporates powerful graphical processing units (GPUs) capable of performing parallel computations necessary for real-time sensor interpretation, environmental modeling, and machine learning inference. It enables the execution of complex algorithms that support autonomous flight, navigation, and system-level decision-making.

Among its core functions, the companion computer processes raw LIDAR data to generate 3D point clouds of the surrounding environment, interprets RADAR signals for obstacle identification and range detection, and decodes optical fiduciary markers for relative pose estimation. It also runs deep learning models for advanced visual tasks, such as object detection, classification, and semantic segmentation, where such capabilities are needed for enhanced situational awareness or target tracking.

The companion computer operates the sensor fusion engine, which integrates data from all onboard sensing modalities, including GPS, UWB, LIDAR, RADAR, and optical cameras, using algorithms such as the Extended Kalman Filter (EKF), Unscented Kalman Filter (UKF), or particle filters. This fusion process produces a unified and robust estimate of the UAV's state in real time, ensuring precise control and coordination with the vessel.

In addition to real-time processing, the companion computer performs comprehensive data logging. It records all sensor outputs, system states, and flight parameters for subsequent post-mission analysis, diagnostics, and system refinement. These logs support mission debriefing, incident investigation, and iterative improvements to system performance.

The software framework deployed on the companion computer is built upon the Robot Operating System 2 (ROS 2), a Linux-based middleware architecture designed for modular, distributed robotic systems. Each major subsystem, such as LIDAR input, UWB processing, optical tracking, sensor fusion, and mission planning, is implemented as a distinct ROS node. These nodes communicate through message-passing protocols (ROS topics) and remote procedure calls (ROS services), enabling flexible integration, real-time operation, and straightforward debugging during development and deployment.

A key software component executed by the companion computer is the high-level mission planner. This module governs the UAV's behavior in vessel-following mode by receiving the fused state estimate of the vessel, predicting its future motion through Kalman filtering or other motion models, and generating optimal UAV trajectories to maintain a fixed position and orientation relative to the vessel. The mission planner dynamically reconfigures UAV behavior in response to unexpected vessel maneuvers or environmental changes, ensuring continuous alignment and mission continuity.

Finally, the companion computer supports a Human-Machine Interface (HMI) layer that exchanges data with the ground control station (GCS). This interface allows operators to monitor the UAV's system status, modify operational parameters, and issue commands. In scenarios requiring human oversight or intervention, the HMI ensures a seamless bridge between autonomous flight control and manual operator input.

It will be appreciated that the accompanying drawings illustrate only some embodiments of the invention and that numerous modifications and further embodiments may be developed based on the present disclosure

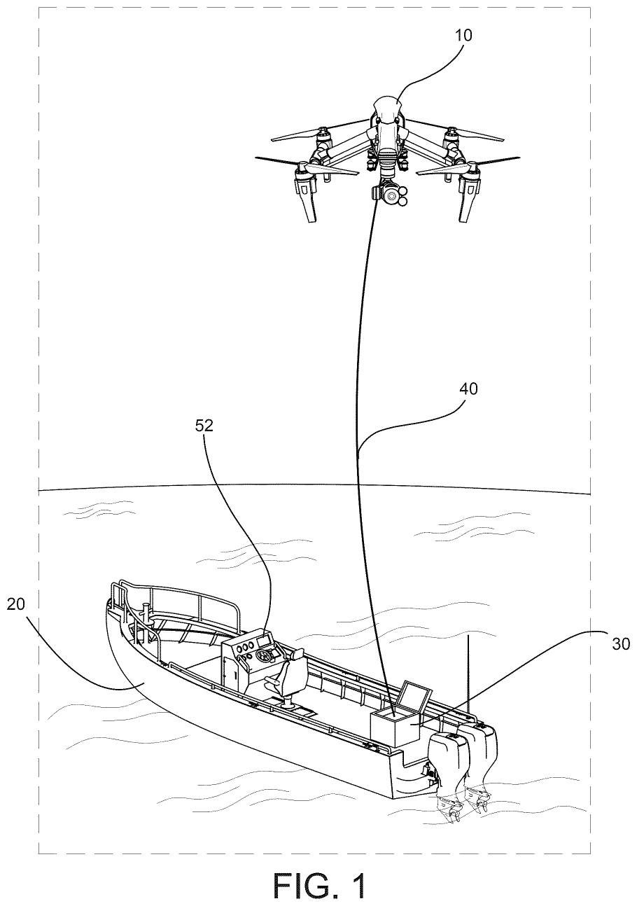

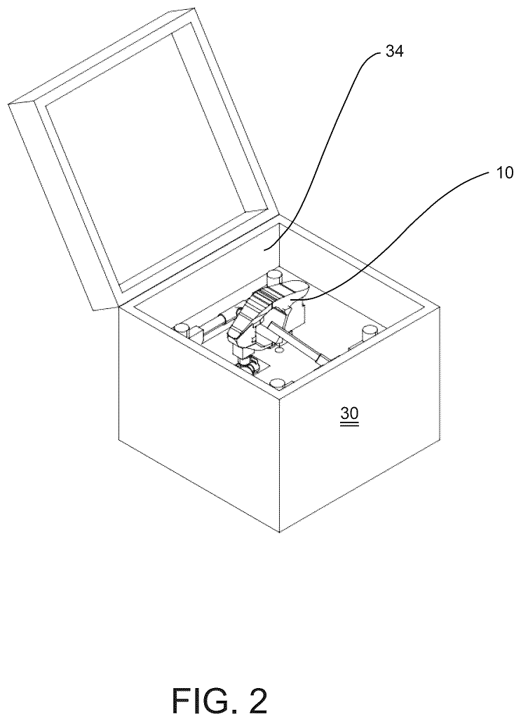

A general layout of the system is illustrated in FIG. 1, and may be seen in more detail in FIGS. 2-7. The invention provides for an unmanned aerial vehicle (UAV) 10, also known as a drone, that is capable of lifting itself, as well as a plurality of sensors. The UAV 10 is coupled to a tether 40, which provides both a data link and power to the UAV 10. On a distal end of the tether from said UAV is a base 30.

The base 30 includes a power source 140 for the UAV 10, and a UAV garage 34 to contain the UAV 10 when it is not in flight. This base 30 encapsulates the UAV 10 and protects it from the elements. The base 30 may include its own power supply, such as a battery or solar, or be wired in to the watercraft's electrical source, which may include at least one of its own battery or at least one generator. The base 30 is mountable on a watercraft 20 to ensure additional security to ensure the base 30 does not fall overboard. The base 30 can be mounted in convenient locations to remain effective, but free from potential obstructions. Therefore, the base 30 also communicates with an interactive screen module 52 with graphic user interface (GUI) 50, as may be appreciated in FIGS. 1 and 7-13.

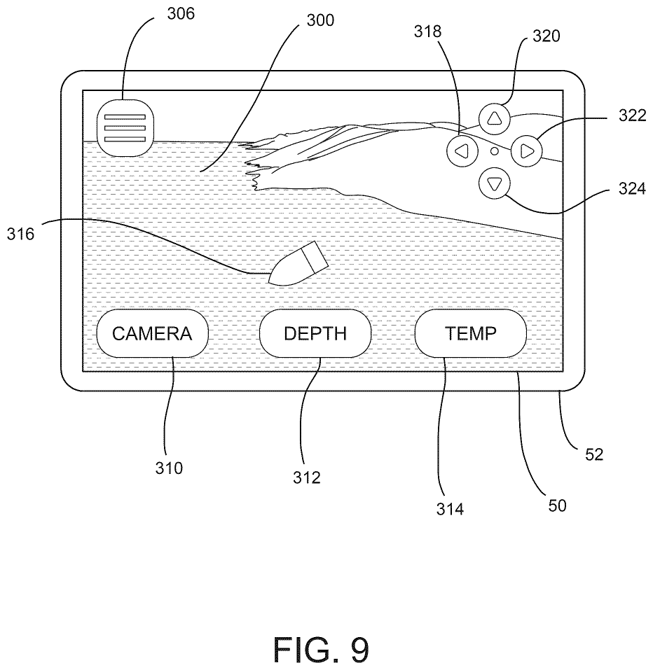

The screen module 52 may be wired directly to the base 30, or, in configurations where the base 30 is out of reach, the screen 52 may communicate wirelessly. Some embodiments may also include a screen 52 that is wired into the electronics cluster on a console of a watercraft 20, alongside other sensors and watercraft equipment. The screen module 52 displays information, as shown in FIGS. 9-13, sent from a plurality of sensors (Elements: 106-112, and 116-126) aboard the UAV 10.

The UAV 10 may include at least one camera 106/108. The camera is ideally a gimballed camera. The camera apparatus may include a high-definition camera 106, and a camera with nighttime viewing options using infrared technology 108. The UAV 10 may also include an infrared thermal sensor, which may also be coupled to a camera 108, a GPS module 120, a phased array radar 118, a LIDAR sensor 112, a bathymetric sensor 116, and a laser 110. The combination of these devices will measure, obtain data, and compile the results in to various views displayed on the screen 52 at the watercraft 20.

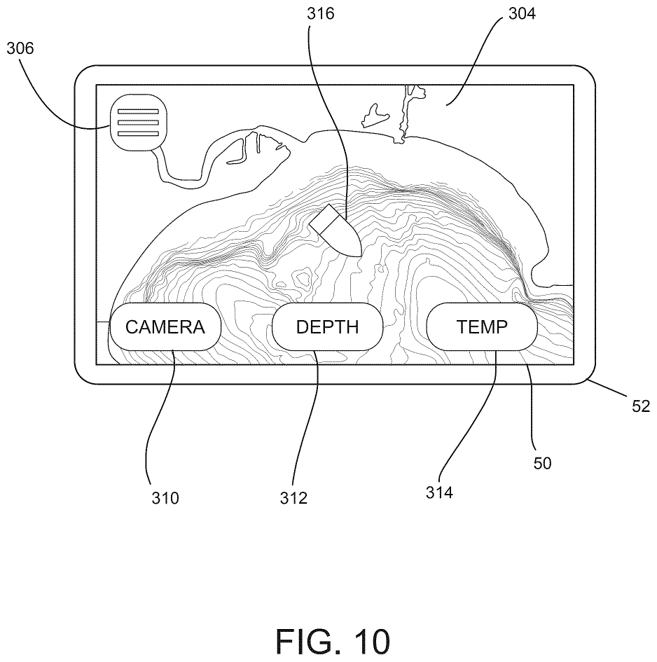

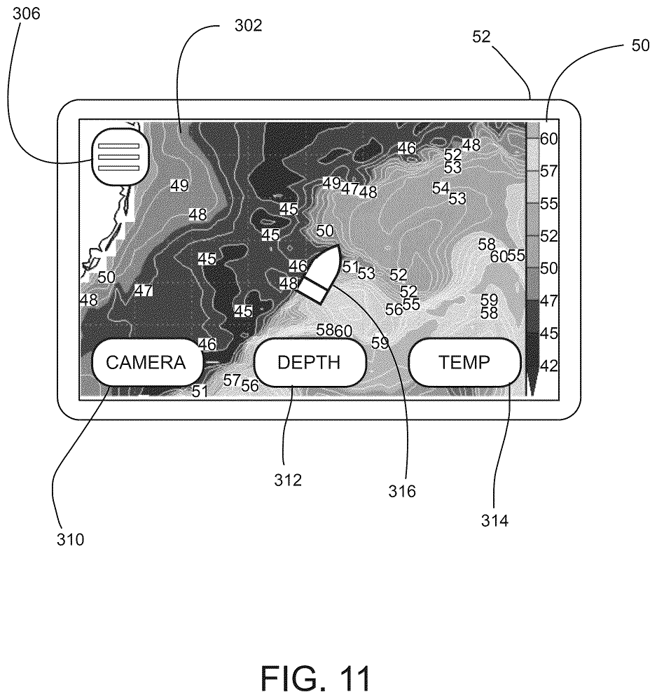

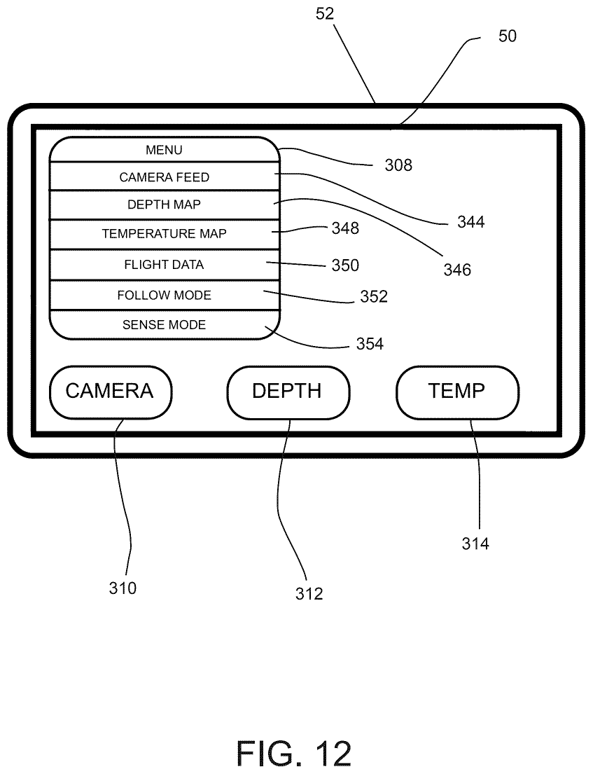

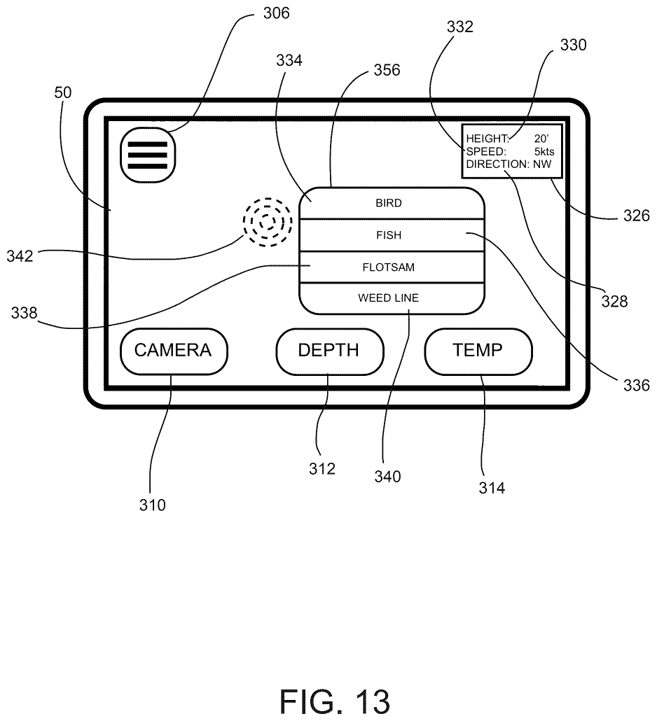

At least one high-definition camera 106 is included in the invention. This camera 106 is mounted to the bottom of the UAV 10 and provides a live aerial view 300, as shown in FIG. 9, of the surrounding area. This live view can also be combined or overlaid with information from other sensors, such as a temperature gradient 302 as shown in FIG. 11, depth information 304 as shown in FIG. 10, and indications of objects and other conditions, as may be appreciated in FIGS. 12-13. Further, the camera 108 may also work with infrared lights to provide nighttime vision of the surrounding area for low-light settings, though it should be appreciated that the strength of the included IR bulbs affects the viewable distance of the nighttime vision. The camera 106/108 may also be used without any overlays if a user wishes to see the conditions of the water and identify them manually, as illustrated by FIG. 13. The camera 106/108 may also be configured for motion detection. The motion detection will need to be able to differentiate between common movements of the water and movements associated with animals and fish.

A thermal sensor, or camera with thermal sensing capabilities 106/108 is mounted to the bottom surface of the UAV 10 to record and relay temperature differences for a user. The user may use this information to view the temperature breaks-the change of temperature of the surface water-shown on the screen 52 to identify fish, as shown in FIG. 11.

Boaters often use sonar equipment to map the real time depth of the water and look for drastic shifts in the depth beneath the boat. However, because the current invention is an aerial device, the system herein uses a bathymetric sensor 116 and a LIDAR sensor 112 to create a map of the underwater surfaces. This real time information will correlate with the depth contours preprinted on the chart plotter via GPS 120.

The Bathymetric Sensor 116 is a small UAV-based surveying system for hydrographic applications ideally suited for generating profiles of inland water bodies. The sensor integrates with the UAV 10, providing a compact and lightweight bathymetric depth finder 116 comprising a tilt compensator, an IMU/GNSS unit with antenna, a control unit and up to two external digital cameras 106/108. The bathymetric sensor 116 will be used for sensing the depth contours and ledges as above.

The LIDAR (Light Detection and Ranging) sensor 112 is also used for creating a 3D survey and mapping. Lidar is a remote sensing method used to examine surfaces by pulsing a laser 110 to measure ranges of variable distances to earth. The light pulse from the laser 110, in combination with imaging obtained by the at least one camera 106/108, generates a three-dimensional shape of a surface characteristics.

A phased array radar 118 is also included. A phased array radar 118 produces an angular scan of the horizon without mechanical rotation of the antenna. This is accomplished by a voltage dependent phase shift in the antenna elements. The ability to scan the horizon without the use of mechanical rotation is advantageous to the unmanned aerial vehicle 10, which requires a precisely tuned rotor 102 calibration, and excess oscillation from mechanical rotation of one or more of the devices could through the UAV 10 out of control, or reduce the efficiency and precision of the flight. The phased array radar 118 will be calibrated to sense the movement of birds, as well as fish jumping out of the water. Further, the phased array radar may also be used to detect flotsam above the waterline.

The system also incorporates at least one Global Positioning System (GPS) module 120. The UAV 10 will have a multi-functional GPS module 120 that is used to record the location of the UAV 10. One use for the GPS module 120 on the UAV 10 is to keep track of where the UAV 10 is, including its coordinates, so that it may also track where its' base 30 is if the UAV 10 experiences a loss of power and is required to return back to the base station 30. In addition, the UAV's GPS module 120 is used in combination with other sensors to relay coordinates for conditions. That is, the GPS module 120 can relay the coordinates of a bird, fish, flotsam weed line, or similar object. A laser module 110 is used to send a beam of light to detect the exact distance of the object from the UAV 10. Once the distance is calculated, the degree of the beam, and the polar direction of the beam, the GPS module 120 can compile the data and associate it with a set of coordinates, which may then be displayed on the user's screen module 52. This is helpful in detecting exactly where objects are located, as a user will either have a GPS 120 built into the watercraft, or a GPS 142C built into the base 30 and/or screen 52 module.

These sensors 106-112, and 116-126 all work together through a processing module on the UAV 10, or at the base station 30, wherein the processor module 134 compiles the raw data received from the sensors 106-112, and 116-126 to arrange and display useful screen frames, as shown in FIGS. 9-13, on the screen module 52 for the user to implement.

These sensors 106-112, and 116-126 allow the system to have a comprehensive survey of the area around the watercraft 20. This information is displayed on the GUI 50 of the screen module 52, however, may also be uploaded to a server by a network uplink through the communication module 130 or network connection module 142, whereby the information can be processed and also relayed to other user's systems and displayed on their GUIs. This allows more information than what a single UAV 10 is able to compile, and provides an abundant amount of information on fishing conditions. The network uplink may be a module located on the UAV 10, base 30, or screen module 52, depending on application. The UAV 10 may be a potential location if a higher altitude is needed for a better signal. In some embodiments, the network uplink is tied in with the watercraft's 20 internet source. Further, in some embodiments, the screen module 52 may be a user's mobile device, such as a smartphone, with its own network connection.

When viewing the control software on the screen 52, there will be a home screen displayed on the graphic user interface 50 with a vessel 316 in the middle of the screen 52 and a function to allow for the background to be in a true north orientation or relative orientation.

In some embodiments, a menu button 306 may be selected to provide a list 308 of interactive options including camera feed function menu button 344 depth map function menu button 346, temperature map function menu button 348, flight fata function menu button 350, follow mode/fish-on mode function menu button 352, sense mode function menu button 354, as may be seen in FIG. 12. From the list of interactive options 344-354 available to a user, an HD Video Screen is selectable. This function calls to the Pan-Tilt-Zoom (PTZ) HD Camera 106/108 on the tethered drone 10, and displays it on the screen 52. The screen 52 will primarily show video 300 of what the PTZ HD Camera 106 is viewing, as shown in FIG. 9. The video feed 300 will include a graphic overlay for directional controls 318-324 of the camera 106, including controls for rotation right 322 and rotation left 318 as well as up angle 320 on the camera 106 and down angle 324 on the camera 106. Included in another graphic overlay on the screen 52 will be flight data 326 as shown in FIG. 13, including but not limited to height 330 of drone 10 and sensors, and GPS speed 332 over the ground. The true direction 328 of the camera will also be graphically displayed, which may also be shown on a vertical compass rose in the bottom of the screen 52 or with the remaining flight data 326.

The user can then maneuver the drone 10 to a particular true or relative direction, angle the camera up or down, and using two fingers contacting the screen 52, may zoom in and out by pulling the fingers together to zoom in and spreading the finders to zoom away from a target. In other embodiments, fingers may be spread to zoom out, and pulled in to zoom in. In some embodiments, zooming manipulates the optical zoom on the PTZ HD camera 106, while in other embodiments zoom is digitally accomplished. Some embodiments include the combination of digital and optical zoom.

A user may use the graphic user interface 50 to obtain information on objects, as shown in FIG. 13. Upon viewing an object, the user may tap the screen location 342 displaying the object. This will send a command to the controller 128 in the tethered drone 10 to emit a laser beam from the laser 110 to pinpoint the GPS location for the target by sensing the angulation and direction of the beam and time it takes for the beam to reach the object, whereby the distance may be obtained. By combining the angulation and orientation of the beam and compiling this with the actual distance from the UAV 10, a location of the object relative to the UAV 10 may be obtained, and thereby, a location of the object relative to the vessel 20 may be obtained by comparing the GPS coordinates of the UAV 10 and the vessel 20 in combination with the altitude data received from the altimeter 122, accelerometer 124, and gyro sensor 126, individually or in combination. This location of the object is automatically displayed on the screen 52 of the graphic user interface 50. The user will then select an icon to the right to identify the target. Choices will include a bird indicator button 334, a fish indicator button 336, a flotsam indicator button 338, and a sea grass/weed line indicator button 340, or in some cases a color break indicator button (not shown, but may be in addition to or replace any of the other buttons 334, 336, 338, 340), which may all appear in response to a tap interaction menu 356, which pops up upon initiating a tap to label an object.

The user can pin point a long target at one end and then midsection and the other end. This will identify a series of targets that are perhaps sea grass. The user will then return to the home screen and see a series of targets labeled as sea grass on the chart in true north with the vessel icon 316 operating the tethered drone in the middle. The user can then maneuver his vessel 20 to the target labeled as sea grass. The user will want to continuously update the targets and mark them in the HD Video Screen 52.

For the Infrared Camera 108, the same as above would occur. The heat of the sea grass will be measured by the IR Camera 108 and displayed on the screen, either overlaying a map, as shown in FIG. 11 or an HD camera feed 300, such as FIG. 9. The user can tap a target and identify the target in the IR Video Screen or use the IR Camera 108 to search general for targets of interest and then switch to HD Camera mode to more clearly identify the target and label it.

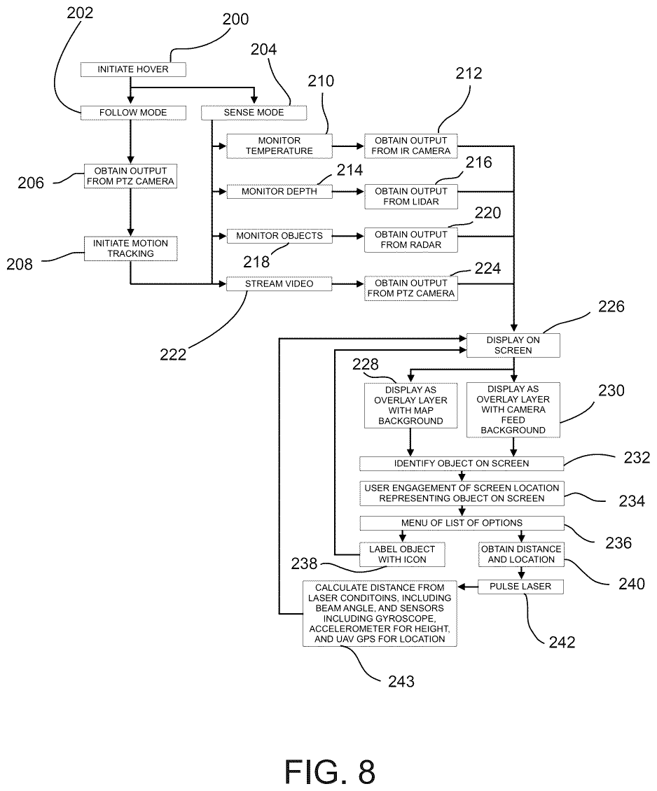

There will also be a “Fish On” mode that can be enabled from a single button. The tethered drone 10 will lower to twenty feet above the vessel 20 and lock onto the stern of the vessel 20 in a relative direction (now matter the direction of the vessel 20 as it lands the fish) and the HD Camera 106 will automatically begin recoding the action and to a portable microchip card, such as the memory module 136 of the controller 128 of the UAV 10, or separate storage media. This may be seen in steps 202, 206, and 208 of the program of FIG. 8.

In some embodiments, the radar 118 is implemented for identifying objects, wherein the radar output is overlayed on a screen graphic user interface 50, wherein the screen may include a map, such as the map views 302 and 304 seen in FIGS. 10 and 11, or HD video feed 300 from the drone's onboard cameras 106/108. Radar functionality will be similar to IR functionality described above. Radar 118 is ideal for scanning large areas and using the HD Camera 106 to specifically identify a target. The Radar 118 will be tuned to find birds flying above the water line. Once the target is noticed, the HD Camera 106 can then be used to specifically identity the target of interest using a similar method as that above.

In some embodiments, LIDAR 112 is used for measuring depth. The depth of the water can be measured so that the measurements will be labeled on the graphic user interface 50 of the screen 52 to identify a depth visually, as may be seen in FIG. 11. For example, by tapping and labeling a curve of depth at 600 feet, a vessel 20 can use real-time information about the depth of the water ahead of the vessel 20, unlike a conventional sonar that only measures beneath the vessel 20.

Some embodiments include the ability release a fishing line from an interactive control on the screen of the graphic user interface 50. Tapping a release button will actuate the opening of a clip physically affixed to the drone 10 so that a user's fishing line will drop above a designated space, but when the clip is closed, the terminal tackle remains above the water line. In some embodiments, the release of the fishing line will be controlled by tension on the fishing line caused by a predator fish striking the live bait and hook, thereby triggering a sensor on the drone to release the fishing line from the clip.

The graphic user interface will include interactive menus 308/356, that when tapped or manipulated by a user's fingers, will execute commands to the sensors of the drone and return data on the graphic user interface 50 of a user's screen 52. The data may be overlaid on a map 302/304 or live video feed 300, or otherwise displayed on a screen 52.

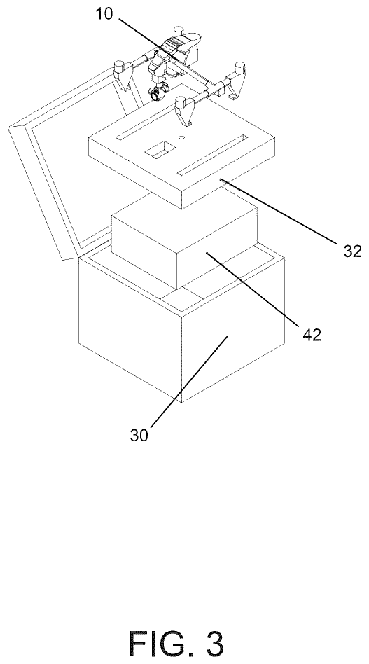

An exemplary embodiment can be seen in FIGS. 1-13. FIG. 1 is a conceptual view of the aerial marine drone system in operation. Shown in the figure are the UAV 10, vessel 20, base station 30, tether 40, and a screen 52 in the console of the vessel 20. FIG. 2 provides a more detailed view of the base station 30. FIG. 2 is an isometric view of the drone 10 housed in the container 30 of the aerial marine drone system. As may be seen, FIG. 2 shows the drone 10, container 30, and garage 34. FIG. 3 is an exploded isometric view of the aerial marine drone system illustrated in FIG. 2. Further shown in FIG. 3 are the integrated landing pad 32 for securing the nested drone 10, and a module for housing the tether, the tether storage system 42.

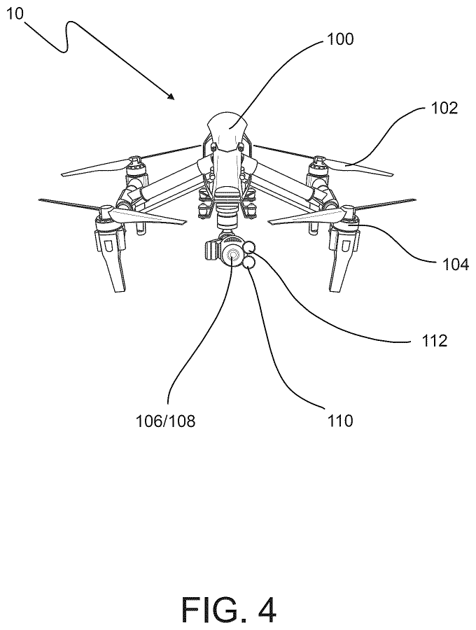

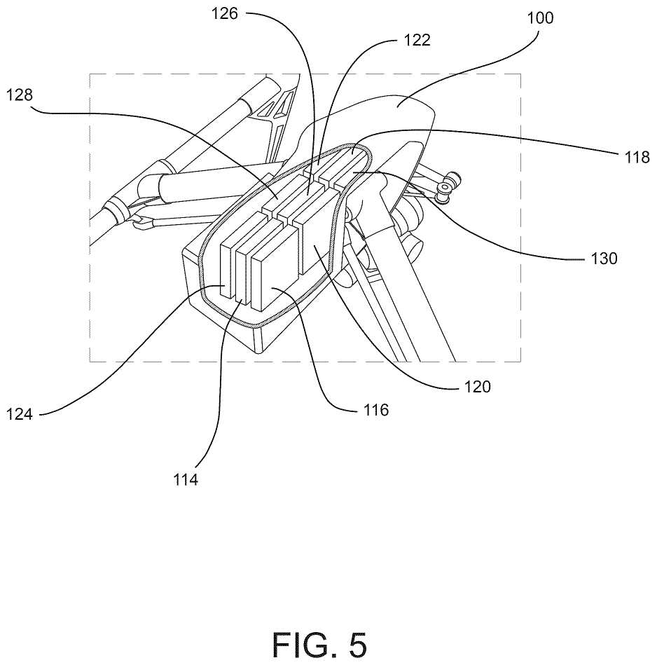

The UAV 10 is shown in more detail in FIGS. 4-6. FIG. 4 is a front perspective view of the unmanned aerial vehicle (UAV)/drone 10 of the aerial marine drone system, and can be seen to include a main housing 100, rotors 102, motors 104, An optical/sensor component of the LIDAR sensor 112 or bathymetric sensor, the laser 110, and at least one of the camera systems 106/108. FIG. 5 is an isolated perspective cut-away view of the internal components of the unmanned aerial vehicle 10 of the aerial marine drone system showing the internal components inside the drone housing 100, including, but not limited to, the battery 114, the bathymetric sensor components 116, the radar 118, the GPS module 120, the altimeter 122, the accelerometer 124, the gyro sensor 126, the controller 128, and the communication module 130.

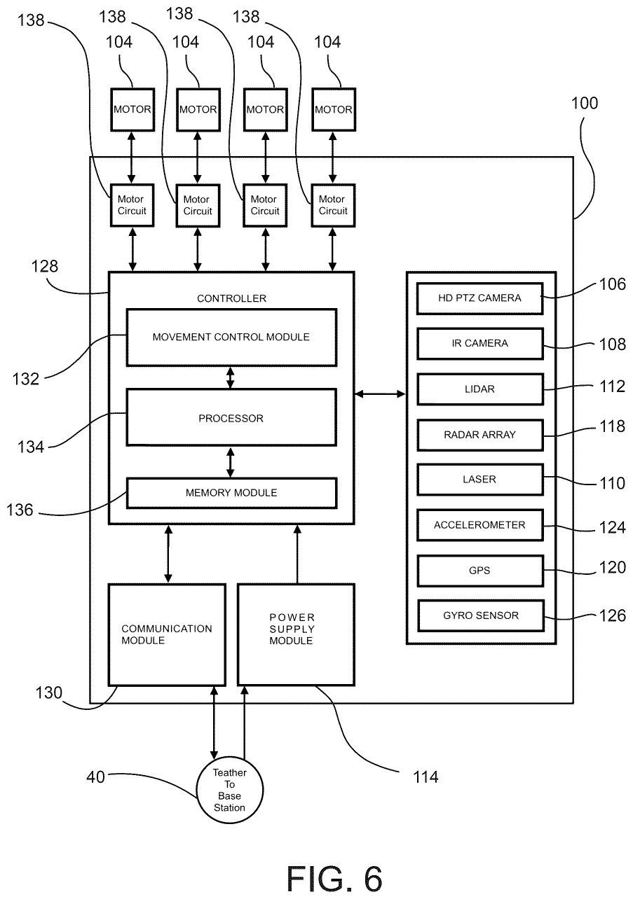

Moreover, FIG. 6 illustrates a schematic view of the unmanned aerial vehicle 10 of the aerial marine drone system so that the internal components may be appreciated. Shown is a controller 128 having a movement control module 132, processor module 134, and memory module 136. The controller 128 is coupled to the communication module 130, power supply module, 114, and a plurality of motor circuits 138, each controlling a motor 104. A tether 40 is shown connecting to the communication module 130, and the power supply module 114, whereby the tether 40 supplies both data communication and power. Also coupled to the controller 128 are a plurality of sensors, including the camera 106, IR camera 108, LIDAR 112, radar 118, laser 110, accelerometer 124, GPS 120, and gyro sensor 126.

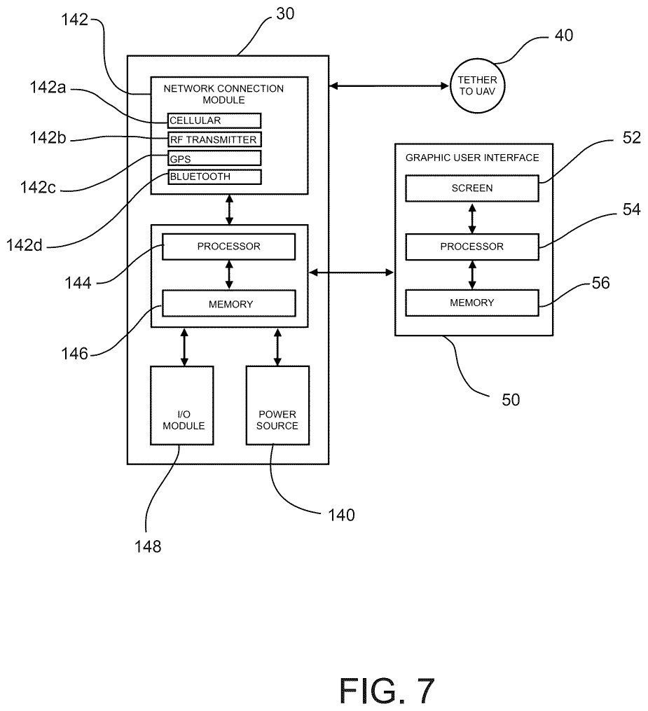

FIG. 7 is a schematic view of the container base 30 of the aerial marine drone system. FIG. 7 shows a block diagram of the base station 30, including the processor 144 and memory 146, coupled to the network connection module 142, input output (I/O) module 148, power source 140, and a screen 52 with a graphic user interface (GUI) 50. The screen module 52 includes a processor 54, and a memory 56 having an executable software thereon. The network connection module 142 includes means for cellular transmission 142a, RF transmission 142b, GPS location 142c, and Bluetooth capabilities 142d.

FIG. 8 is a flow diagram of a functional aspect of the aerial marine drone system. Shown are the steps in a method of a system that a user will interact with on the graphic user interface 50. These steps include initiating hover 200, which will allow the UAV 10 to take of from its base station 30. A user will then select a “follow” mode 202 or a “sense” mode 204. Follow mode 202 will follow the craft 20 and record, for example, when a user is fishing, to capture video of the experience, sometimes referred to as “fish-on mode”. The “follow” mode 202 initiates a tracking program which obtains 206 a video feed from the PTZ camera 106 and uses object identification to identify and lock on to the watercraft 20 and follow physically and in the camera view in an initiated motion tracking function 208. The video feed 300 is then streamed 222 from a camera output 224, displayed 226 on the screen 52, the user can then interact with the graphic user interface, wherein the display may be overlayed as a layer with a map background 228 or displayed as an overlay layer with camera feed background 230. With the mode 228/230 selected, a user may identify an object 230 on the graphic user interface 50 displayed on the screen 52. Next, a user may tap an object engaging a screen location representing the object 234. Upon tapping the object, a tap interaction menu 356 populates on the GUI. From the list, the user may select a label populated 238 in the menu 356, or obtain a distance and location 240 by pulsing 242 the laser 110. Form the laser pulse, the program will calculate 243 the distance from the laser 110 conditions, including beam angle and sensors including the gyroscope 126, accelerometer 124 for height, and the GPS 120 for location of the UAV 10.

The “sense” mode 204 will provide a list of options for a user to select, including options to monitor water temperature 210, monitor water depth 214, monitor objects in the water and air 218, and stream live video 222. If a user selects to monitor temperature 210, the IR camera is engaged 212, and the data output will be quantified into visually viewable data on the screen of the GUI 226. If depth monitoring 214 is selected, the system will obtain an output from a LIDAR 216 and the data output will be quantified into visually viewable data on the screen of the GUI 226. Selecting monitor objects 218 will bring up a feed from a radar array 224 with graphical representations of objects in the viewable area. In most modes, streaming video is integrated into the mode. Streaming video 222 will bring up an output 224 from the PTZ camera 106. Once the video is obtained from the subfunctions 210-224 of the sense mode selection 204, the user can then interact with the graphic user interface as described above in steps 226-243.

Each mode is displayed on the screen of the GUI 226. For most modes, the output of these modes will be through layers, wherein the output will be in a foreground layer, and a background layer may be selected from a live video feed 300, or a map 302-304, by tapping a button from a list of buttons, including a camera button 310, a depth button 312, and a temperature button 314. These buttons 310-314 may be present on the screen as quick tap buttons to move between background layer. In some embodiments, there may also be a quick button for “Fish-On” mode, but in others, “Fish-On” mode, also known as “Follow Mode” 352 will be present in a menu 308. A user can select variable locations on the screen of said GUI 50, which will bring up an option to label an object 356, or receive distance data 326. Selecting obtaining distance 326 will pulse a laser 110 which, when combined with output from other sensors including a gyroscope 126, accelerometer 124, GPS 120, and/or altimeter 122, will allow for the calculation of distance, and location based on the beam angle of the laser 110, orientation, distance, current height of the UAV, and GPS location of the UAV 10.

This functionality can be particularly seen in FIGS. 9-13 as described above. FIG. 9 is a screen 52 layout of a graphic user interface 50 illustrating functionality with a video feed 300 background. FIG. 10 is a screen 52 layout of a graphic user interface 50 illustrating functionality with a depth information 304 background. FIG. 11 is a screen 52 layout of a graphic user interface 50 illustrating functionality with a temperature gradient 302 background. FIG. 12 is a screen 52 layout of a graphic user interface 50 illustrating functionality with expanded menu 308 displayed. FIG. 13 is a screen 52 layout of a graphic user interface 50 illustrating functionality including interactive tapping 324, tap interaction menu 356, and flight data 326.

An exemplary embodiment of the invention provides a marine drone system, as shown in FIG. 1, comprising a container 30 configured to be mountable on an upper surface of a watercraft 20, an unmanned aerial vehicle 10, a tether 40 coupling said unmanned aerial vehicle 10 to a said container 30, and a control module with screen 52 and graphic user interface 50. The control module may be integrated to the screen 50, as shown in FIG. 7, wherein the control module has a screen 52, processor 54, and memory 56. The container 30 further includes a means of supplying power 140 to components of said marine drone system. The control module with screen 52 and graphic user interface 52 includes a processor 54 and a memory 56. The memory 56 contains a program stored thereon that, once executed by the processor provides for the steps of: i) displaying a menu 308 on said graphic user interface 50 that includes interactive locations 310, 312, 314, 344, 346, 348, 350, 352, and 354 for: displaying a video feed 310/344, displaying depth information 312/314 from a LIDAR 112 output, and displaying temperature information 314/348 from an infrared camera 108 output, and displaying a map 302/304, ii) selecting at least one of said interactive locations 310, 312, 314, 344, 346, 348, 350, 352, and 354 on said graphic user interface 50, iii) displaying a water temperature when said location on said graphic user interface for water temperature 314/348 is tapped, iv) displaying water depth when said location on said graphic user interface for water depth 312/346 is tapped v) displaying objects 356 when said location on said graphic user interface for objects 342 is tapped, and vi) displaying an HD video feed 300 when said location 310/344 on said graphic user interface 50 for HD video feed is tapped. The display of this program contained on the memory can be seen in FIGS. 9-13.

In some embodiments, the unmanned aerial vehicle 10, as shown in FIGS. 4-6, of said marine drone system further includes, a weather-proof and water-proof casing 100 and a plurality of sensors 106-112, and 116-126 coupled to said unmanned aerial vehicle 10, including at least one camera 106, at least one infrared camera 108, at least one radar module 118, at least one LIDAR module 112, at least one GPS module 120, and at least one bathymetric sensor 116. The unmanned aerial vehicle 10 also includes a plurality of propellers 102 capable of lifting said unmanned aerial vehicle 10 and supporting the weight of said unmanned aerial vehicle 10 and a tether 40. The unmanned aerial vehicle 10 further includes a laser 110, configured to communicate with at least one sensor in said plurality of sensors 106-112, and 116-126 to obtain information from said sensor, and obtain a GPS coordinate location for objects detected by said at least one sensor and measured by said laser 110.

In some embodiments, the tether 40 includes an electrical supply wiring and data wiring within the overall sheath of the tether 40. The tether 40 supplies said unmanned aerial vehicle 10 with power through said electrical supply wiring in the tether 40, and provides for a bi-directional communication link through said data wiring in the tether 40. While the individual wiring may not be shown in the drawings, it should be appreciated by a person of skill in the art that the individual wires may have their plastic jackets fused together, or may be in a hollow sheath, as is typical in production of data and communication wires, for example, in category wiring.

In some embodiments, as may be appreciated in FIGS. 5-7, the marine drone system further includes at least one control module, such as the processor 54 and memory 56 of the screen 52, providing an interactive graphic user interface 50 on a display 52, wherein said control module 52/54/56 includes a processor 54 configured to execute a program stored on a memory 56, wherein said program is configured to: i) show a video output 300, ii) show a visual radar output (such as an overlay on the maps 302 and 304), iii) show a visual LIDAR output 304, iv) show a GPS location of said unmanned aerial vehicle 10, and v) show a GPS location of said graphic user interface 50. The at least one control module includes means for relaying information between said unmanned aerial vehicle 10 and said display 52 with said interactive graphic user interface 50. For example, the means for relaying information may include the display module 52, the Network Connection Module 142 of the base 30, and the tether 40 to the controller module 128 of the UAV 10. Further the at least one control module 142 includes a network uplink 142a for uploading identification information on fishing conditions.

In an exemplary embodiment of the invention the marine drone system includes an electronic device having a processor 134 and a memory 136 in the control module 128 of the unmanned aerial vehicle 10. The memory 136 includes instructions stored thereon that, once executed by the processor 134, performs a plurality of steps, as may be seen in FIG. 8. The steps include initiating a hover mode 200 of flight, selecting at least one mode including following mode 202 and sense mode 204, and obtaining 206 a video feed 300 from a PTZ camera 106 if follow mode is selected, wherein once said video feed 300 is obtained 224, said mode initiating a tracking function 208 whereby said tracking function will track a watercraft 20, stream 222 video 300 of said tracking, display said video 226 feed on a display screen 52 of a graphic user interface 50. The steps further include providing a list of additional functions if sense mode 204 is selected, including options for monitoring water temperature 210, monitoring water depth 214, monitoring objects 218, and streaming video 222, wherein said monitoring water temperature includes obtaining 212 an output from an IR camera 108, said monitoring water depth includes obtaining 216 an output from a LIDAR sensor 112, said monitoring objects includes obtaining 220 an output from a radar 118, and said streaming video includes obtaining 224 an output from a PTZ camera 106.

The steps may continue by displaying 226 on a graphic user interface 50 of a screen 52 the video output 300 from said follow mode and said output from said sense mode. The steps may also continue by displaying 228/230 on said screen 52 the video 300 output from said follow mode or said output mode as an overlay layer with at least one of a map 302/304 or a camera feed 300 as a background layer, identifying 232 objects displayed on said screen 52, tapping 234, by way of user interaction, a screen location 342 representing said object, and selecting 236, from a list 356 of options, one option thereby executing a sub function of at least labeling 238 said object with an icon, and obtaining a distance 240 of said object or condition, whereby a laser pulses 242 and said distance is calculated 243 from the results of the laser 110 pulse, the beam angle of the laser 110, and outputs from sensors including a gyroscope 126, an accelerometer 124 for height, and a GPS 120 for exact location of said UAV 10, whereby the resulting information is displayed 226 on said screen 52.

An exemplary embodiment of the invention provides a method for a marine drone system. The method comprises providing a marine drone system, as recited above, and including an unmanned aerial vehicle 10 and a control module with screen 52 and graphic user interface 50. The method continues by displaying a menu 308 on said graphic user interface 50 that includes interactive locations for: i) displaying a video feed 310/344, ii) displaying depth information 312/346 from a LIDAR 112 output, and iii) displaying temperature information 314/348 from an infrared camera 108 output; and displaying a map 302/304. The method also includes the steps of selecting at least one of said interactive locations 310, 312, 314, 344, 346, 348, 350, 352, and 354 on said graphic user interface 50, displaying a water temperature when said location on said graphic user interface for water temperature 314/348 is tapped, displaying water depth when said location on said graphic user interface for water depth 312/346 is tapped, displaying objects 356 when said location on said graphic user interface for objects 342 is tapped, and displaying an HD video feed 300 when said location 310/344 on said graphic user interface 50 for HD video feed is tapped.

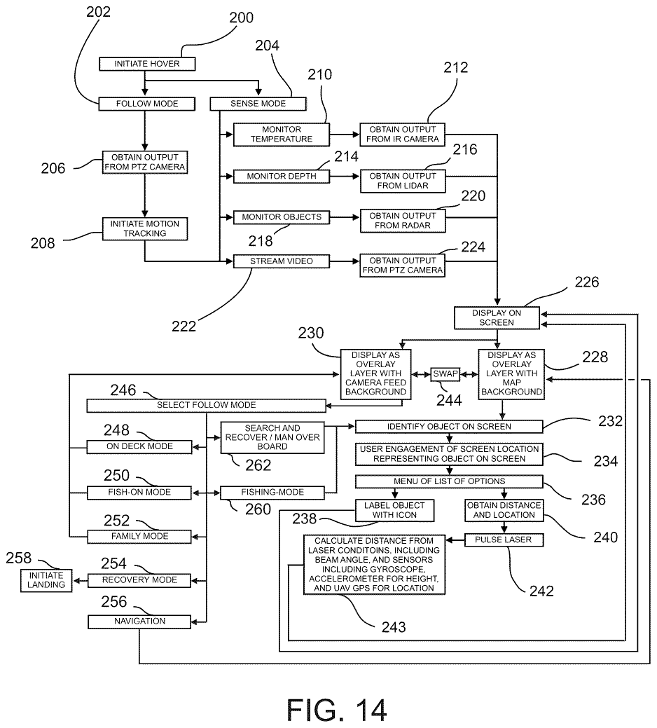

The aerial marine drone system and methods of the present disclosure also provides an enhanced embodiment, incorporating additional tracking modes as described above, including Family (Sentry) mode, Fish-On mode, an enhanced Fishing mode, a Recovery mode and Emergency Recovery mode, enhanced Navigation mode, On Deck mode, and Man Overboard (Search and Recover) mode. These new enhanced modes may be used to provide a marine drone system that enhances navigational awareness by autonomously delivering a live, elevated video feed of the vessel's surroundings to assist in piloting, docking, and obstacle avoidance; to improve maritime safety through a Search and Rescue (SAR) mode that enables persistent visual tracking and geolocation of persons who have fallen overboard, even as the vessel is in motion; to provide autonomous UAV tracking of the vessel using sensor fusion and multi-modal localization, allowing the UAV to maintain stable flight and video capture over a moving vessel without manual control; to enable automated takeoff, landing, and recovery of the UAV from a dynamically moving vessel, thereby reducing reliance on manual piloting and increasing operational reliability; and to provide a recreational videography tool through configurable modes such as Fish-On Mode and Sentry Mode, allowing users to document events and monitor guests engaging in water-based activities near the vessel; to facilitate structured environmental and operational data collection, with onboard storage and automated upload capabilities, supporting post-mission analysis, system diagnostics, and regulatory compliance. This enhanced version of the apparatus and system are particularly shown in FIGS. 14-24, in further combination with and context of FIGS. 1-13.

FIG. 14 illustrates a flow diagram of a functional aspect of the aerial marine drone system with enhanced visual tracking functionality. The diagram begins with initiating hover mode 200, followed by selecting at least one of the primary operational modes: follow mode 202 or sense mode 204. If follow mode 202 is selected, a video feed is obtained 206 from a PTZ camera, and a tracking function is initiated 208.

Sense mode includes monitoring temperature 210 by obtaining an output from the IR camera 212, monitoring depth 214 by obtaining an output from the LIDAR 216, monitoring objects 218 by obtaining an output from a RADAR 220 or using advanced image processing from the PTZ camera, streaming video 222 by obtaining an output from the PTZ camera 224.

The GUI displays the data outputs 226 on screen, including combining follow and sense mode data into overlays 228. The overlays 228 are shown layered 230 on a background such as a camera feed or map. Objects on screen are identified 232, and the user can tap a location 234 representing a detected object. Upon user selection 236, the system allows for sub-functions including object labeling 238. The system may then perform a distance measurement 240 using a laser pulse 242, which calculates object distance 243 using sensor fusion, factoring the laser pulse result, beam angle, UAV gyroscope 126, accelerometer 124 for altitude, and GPS module 120 for exact coordinates. From step 230 (displaying as an overlay layer), the flow branches into a swap function 244 allowing the user to switch between active and secondary feeds (e.g., camera-to-map). The follow mode path continues with selecting a follow sub-mode 246.

Once a sub-mode is selected, such as Fish-On Mode 252, Family Fun Mode 254, or Man Overboard Mode 256, the system locks the UAV camera onto the corresponding target. In Fish-On Mode 252, the UAV camera locks onto a stern position and initiates recording 248 of the fishing activity. In Family Fun Mode 254, the UAV locks onto a designated GPS location and maintains a persistent video stream 250 of the activity in that location. In Man Overboard Mode 256, the UAV detects and locks onto a person in the water. Upon entering this mode, the system initiates an active geolocation function 258, determining the precise coordinates of the individual. A visual tag is applied to the individual on screen, and the system then begins autonomous recovery tracking 260, which maintains UAV camera lock on the subject even as the UAV repositions. The process concludes with a secure tracking and display phase 262, ensuring continuous video feedback and dynamic positional updates on the GUI until manual override or mission completion.

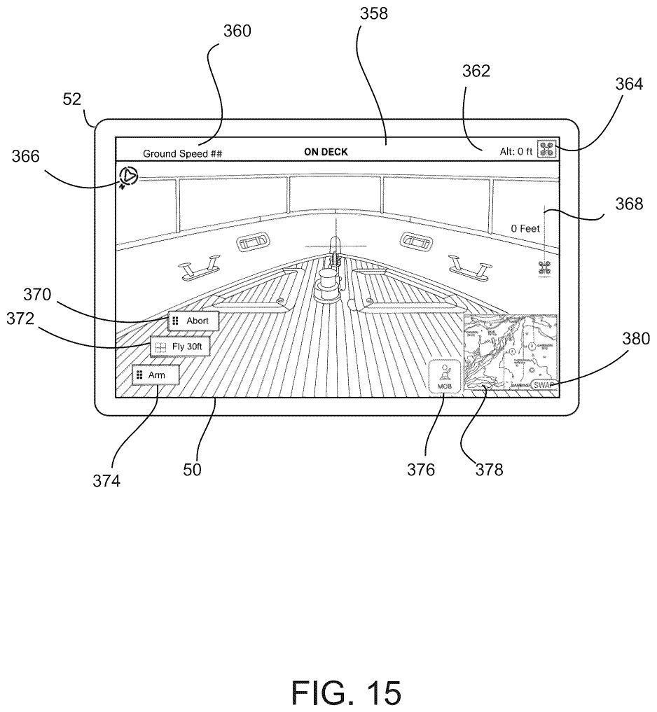

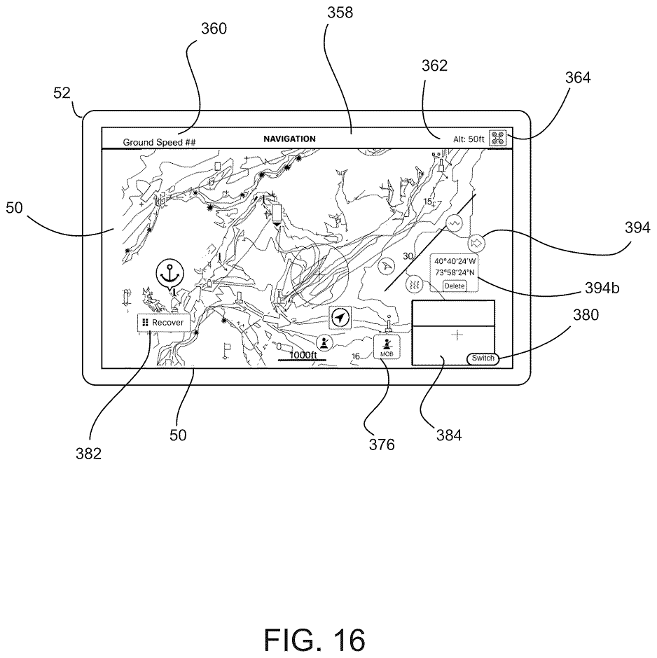

FIG. 15 illustrates a screen layout of the graphic user interface (GUI) 50 and screen 52 in On Deck mode, a standby mode showing the watercraft deck. The primary camera feed displays the deck surface, while the interface presents a status bar 368 indicating an altitude of 0 ft, signifying UAV presence directly above the watercraft. GUI menu bar 358 shows the mode, ground speed 360, and displays altitude 362, and the status icon 364 of the UAV, thereby displaying system telemetry, including battery, signal, and orientation. The navigation mini-window 378 appears in the lower right corner, showing map. A swap button 380 enables toggling the navigation view 378 and a live feed (see live feed 384 in FIG. 16). Prominently located, a Man Overboard button 376 provides immediate mode switching. The control layout includes the navigation compass 366. The GUI also shows status buttons for arming the UAV 374, flying to a predetermined altitude 372, and an Abort button 370.

FIG. 16 illustrates the GUI 50 and screen 52 in Navigation mode, where the main view displays the map interface. The navigation display shows previously labeled objects 394 using icon overlays and associated GPS coordinates 394b. GUI menu bar 358 shows the mode, ground speed 360, and displays altitude 362, and the status icon 364 of the UAV. The Man Overboard button 376 remains accessible in all views. The video feed 384 is retained in the corner for contextual awareness. The user may use the swap button 380 to elevate the video feed 384 into the primary position. The GUI also shows status buttons for arming the UAV 382.

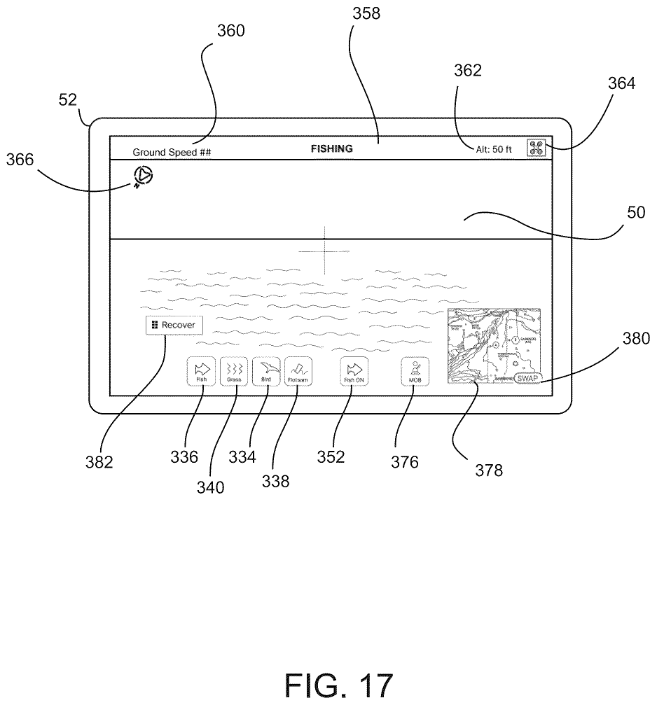

FIG. 17 shows the GUI 50 and screen 52 in Fishing mode, where the user views an active camera feed of the water. Icons are overlaid to indicate objects (e.g., birds icon 334, fish icon 336, grass icon 340, and flotsam icon 338) or debris and other selectable labeling options. The Fish-On button 352 is visible to switch from labeling objects to Fish-On mode for recording the event. These icons present an alternative embodiment from the drop-down menu and are thereby presented directly on screen. Man Overboard button 376 remains active. The navigation window 378 is shown as an inset view, and may be toggled to the primary layer by selecting the swap button 380. The compass 366 is shown in the upper left corner. Recover button 382 is also present. GUI menu bar 358 shows the mode, ground speed 360, and displays altitude 362, and the status icon 364 of the UAV.

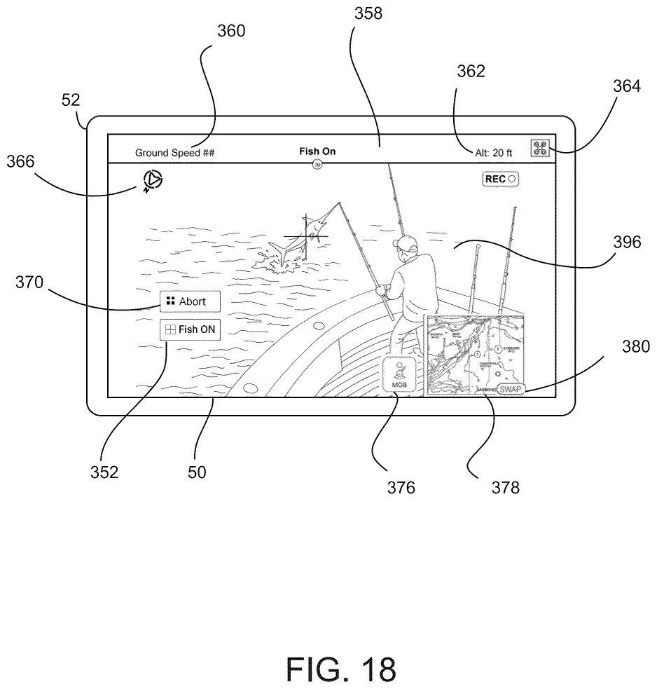

FIG. 18 depicts the GUI 50 and screen 52 in Fish-On mode, specifically designed to record fishing activity from the stern. The PTZ camera feed is angled to show the fisherman 396, fishing line, and stern of the boat in one shot. A red “REC” indicator is displayed in the corner of the feed to signify active recording. The navigation window 378 is visible as a secondary view, which may be brought to the forefront using the swap button 380. The Man Overboard button 376 remains accessible, as do controls for Fish On status button 352, and Abort button 370. The control layout includes the navigation compass 366. GUI menu bar 358 shows the mode, ground speed 360, and displays altitude 362, and the status icon 364 of the UAV.

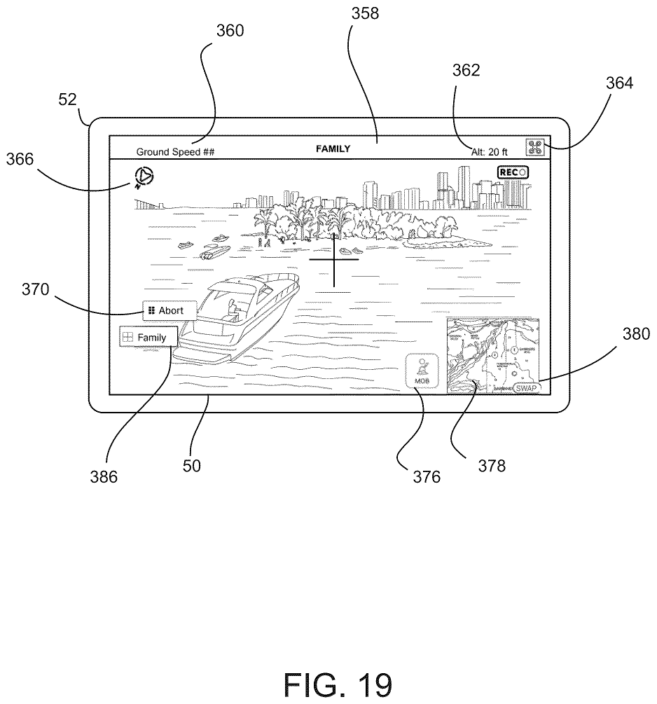

FIG. 19 illustrates Family mode (also referred to as Family Fun mode or “Sentry Mode”), shown on GUI 50 and screen 52. The primary video feed shows a remote scene, such as a family gathering on an island, tracked and recorded by the UAV. The video feed includes a “REC” label in the corner to indicate active recording. The navigation inset 378 is active and can be toggled into the main view using swap button 380. The Man Overboard button 376 remains accessible, as do controls for Family status button 386, and Abort button 370. The control layout includes the navigation compass 366. GUI menu bar 358 shows the mode, ground speed 360, and displays altitude 362, and the status icon 364 of the UAV.

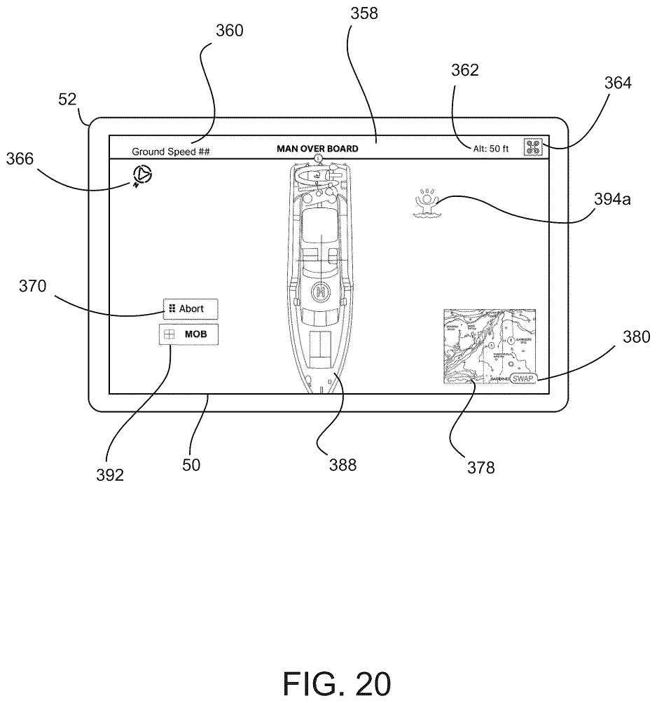

FIG. 20 shows the GUI 50 and screen 52 in Man Overboard mode (Bird's Eye View). The UAV camera feed displays a zoomed-out boat video feed 388 with an icon for an individual overboard, marked by icon 394a. This tag is applied after the user taps the screen on the identified individual. The labeling process utilizes onboard tracking and targeting mechanisms, distinguishing this label from other object types. The navigation inset 378 is active and can be toggled into the main view using swap button 380. The Man Overboard button 376 remains accessible, as do controls for Man Overboard status button 392, and Abort button 370. The control layout includes the navigation compass 366. GUI menu bar 358 shows the mode, ground speed 360, and displays altitude 362, and the status icon 364 of the UAV.

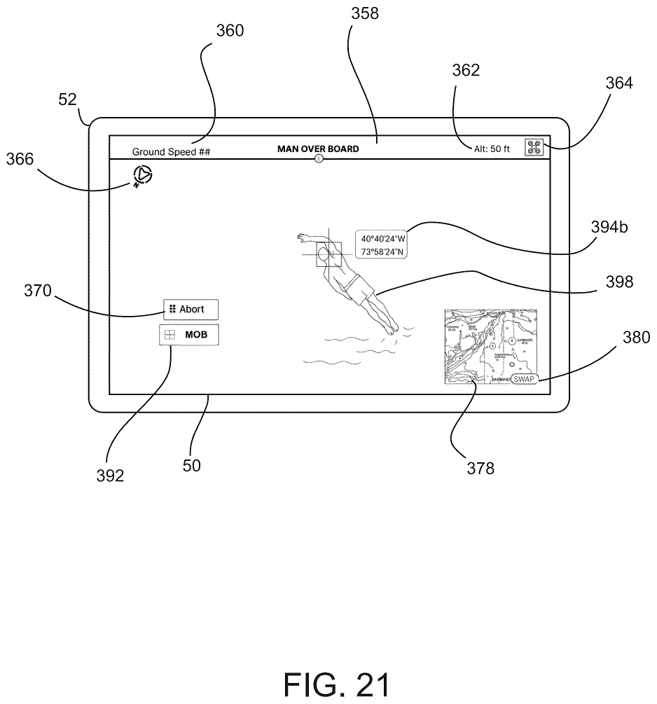

FIG. 21 shows the GUI 50 and screen 52 in Man Overboard mode (Zoomed View), focusing the camera feed on the overboard individual 398. The system shows the real-time position of the person, labeled with dynamic geographical coordinates using icon 394b to denote the exact GPS coordinates derived via internal sensor triangulation. The active tracking interface supports persistent lock. The navigation inset 378 is active and can be toggled into the main view using swap button 380. The Man Overboard button 376 remains accessible, as do controls for Man Overboard status button 392, and Abort button 370. The control layout includes the navigation compass 366. GUI menu bar 358 shows the mode, ground speed 360, and displays altitude 362, and the status icon 364 of the UAV.

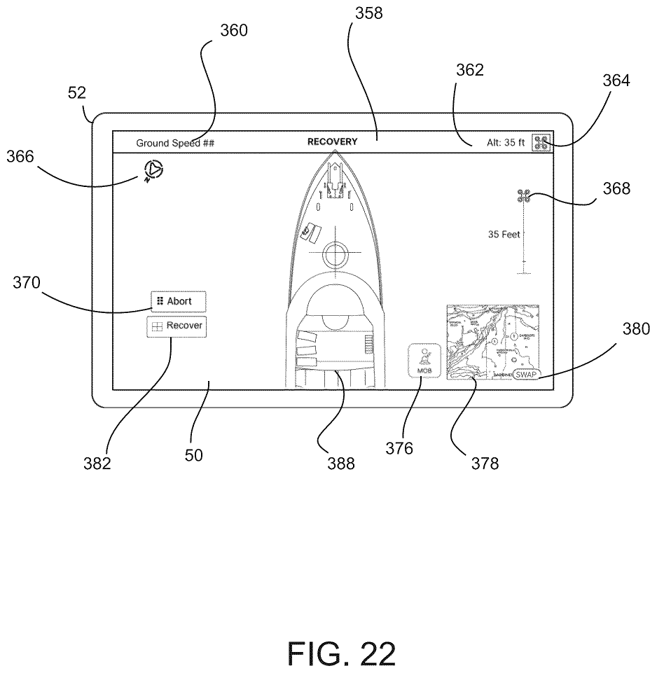

FIG. 22 illustrates the GUI 50 and screen 52 during the initial phase of Recovery mode, where the UAV is in midair preparing for descent. The altitude status bar 368 displays a current height of 35 feet. The UAV camera feed displays a zoomed-out boat video feed 388. The navigation inset 378 is active and can be toggled into the main view using swap button 380. The Man Overboard button 376 remains accessible, as do controls for Recover status button 382, and Abort button 370. The control layout includes the navigation compass 366. GUI menu bar 358 shows the mode, ground speed 360, and displays altitude 362, and the status icon 364 of the UAV.

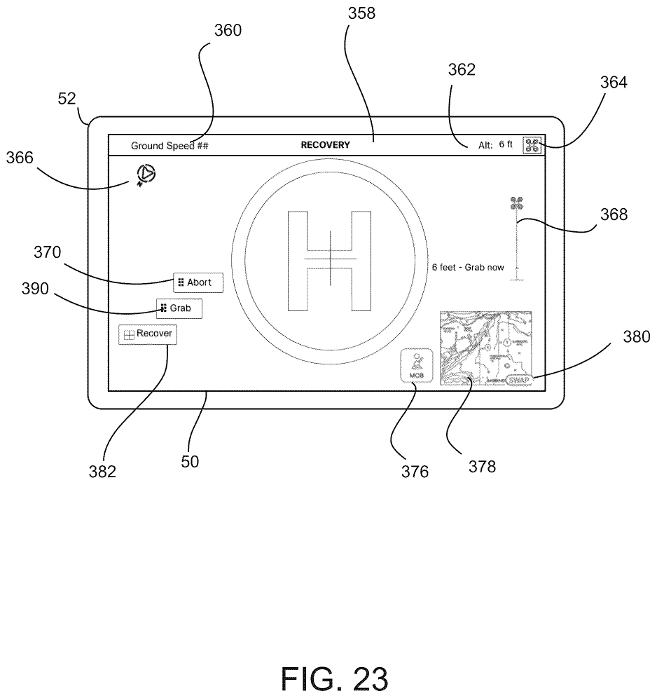

FIG. 23 illustrates the GUI 50 and screen 52 during the later phase of Recovery mode, with the UAV hovering at 6 feet above the deck. The altitude bar 368 includes the text “6 feet-grab now,” instructing the user that the UAV is within manual reach. The navigation inset 378 is active and can be toggled into the main view using swap button 380. The Man Overboard button 376 remains accessible, as do controls for Recover status button 382, Grab button 390 and Abort button 370. The control layout includes the navigation compass 366. GUI menu bar 358 shows the mode, ground speed 360, and displays altitude 362, and the status icon 364 of the UAV.

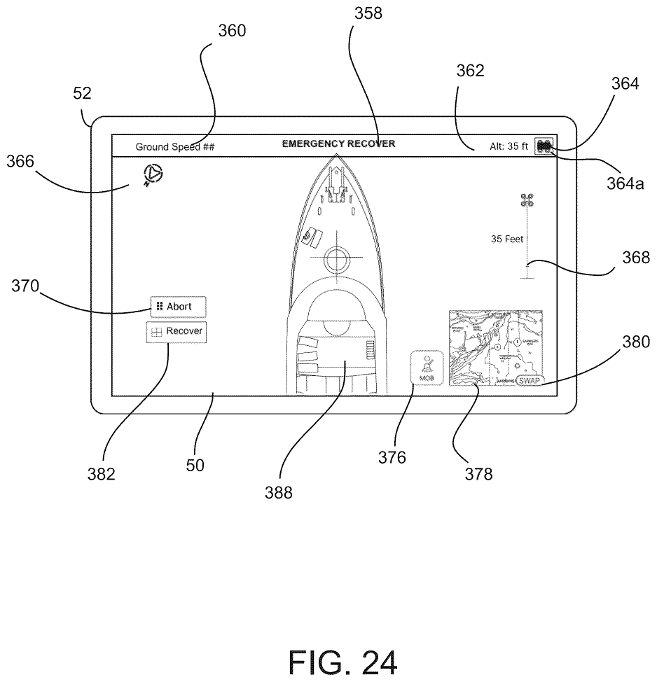

FIG. 24 illustrates the Emergency Recovery mode, activated automatically due to a power failure or connectivity issue. This is indicated on the GUI 50 by a fault icon 364a superimposed above the status icon 364. The UAV's current height is indicated on the altitude bar 368. The screen 52 shows a video feed of the boat 388. The navigation inset 378 is active and can be toggled into the main view using swap button 380. The Man Overboard button 376 remains accessible, as do controls for Recover status button 382 and Abort button 370. The control layout includes the navigation compass 366. GUI menu bar 358 shows the mode, ground speed 360, and displays altitude 362, and the status icon 364 of the UAV.

In the enhanced exemplary embodiment of the invention provides a method for a marine drone system is provided. The system includes an unmanned aerial vehicle (UAV) 10 and a control module with screen 52 and graphic user interface (GUI) 50. The control module includes a processor 54 configured to execute a program stored on a memory 56. The memory 56 includes instructions that, when executed by the processor 54, perform the steps of initiating a hover mode 200 of flight and selecting at least one mode, including a follow mode 202 and a sense mode 204.

If follow mode 202 is selected, the UAV 10 obtains a video feed from a PTZ camera 106, and the mode initiates a tracking function 208. The tracking function is configured to track a watercraft 20, stream video 300 of said tracking, and display the video feed 300 on the screen 52 of the GUI 50. The follow mode 202 further includes a plurality of tracking sub-modes selectable via the GUI 50. These include: a Fish-On Mode 252 configured to lock the UAV camera 106 onto a stern portion of the watercraft 20 and record fishing activity; a Family Fun Mode 254 configured to lock the UAV camera 106 onto a designated geographic location and maintain a video stream of that location; and a Man Overboard or Recovery Mode 256 configured to lock the UAV camera 106 onto a detected person in the water and maintain the lock during search and recovery operations. Each of the tracking sub-modes 252, 254, 256 is initiated by tapping a corresponding location on the GUI 50.

If sense mode 204 is selected, the GUI 50 provides a list of additional functions including options for monitoring water depth 214, monitoring objects 218, and streaming video 222. Monitoring water depth includes obtaining an output from a LIDAR sensor 112. Monitoring objects includes obtaining an output from a phased array radar 118. Streaming video includes obtaining a feed from a PTZ HD camera 106. In either mode, the GUI 50 displays outputs from the follow mode 202 and sense mode 204.

The GUI 50 further includes logic for displaying the outputs from follow mode 202 or sense mode 204 as overlay layers with at least one of a map 228 or a camera feed 300 as the background layer. Objects are identified on the screen 52, and users may tap 234 a screen location representing the object. In some embodiments, a menu 356 appears offering sub-functions, including labeling 238 the object with an icon and calculating distance 240 using a laser pulse 242. The distance is determined based on the laser 110 pulse, beam angle, and outputs from other onboard sensors including a gyroscope 126, an accelerometer 124 for height, and a GPS module 120 for exact location of the UAV 10. The resulting information is displayed 226 on the screen 52.

The GUI 50 presents interactive locations for the following: displaying a live video feed 300, displaying depth information from the LIDAR 112 output, displaying objects 394, and displaying a map 378. Additionally, dedicated GUI locations initiate display modes 352, 370, 372, 374, 376, 382, 386, 390, 392: the Fish-On Mode 250 streams live footage of the stern when the Fish-On icon is tapped; the Family Fun Mode 254 streams video from a locked GPS coordinate; the Man Overboard Mode 256 streams footage of a detected person overboard. Each of these is accessible via respective GUI interface buttons 352, 370, 372, 374, 376, 382, 386, 390, 392.

In some embodiments, the marine drone system further includes a container 30 mountable on an upper surface of a watercraft 20. The container 30 includes a means of supplying power 140 to the components of the marine drone system, including the UAV 10 and the control module 52. The UAV 10 is tethered via a tether 40 that includes electrical supply wiring and data wiring. The electrical wiring delivers power to the UAV 10, while the data wiring provides a bi-directional communication link.

In some embodiments, the UAV 10 includes a weather-proof and water-proof casing 100 and a plurality of sensors 106-126. These include a PTZ camera 106, an infrared camera 108, a LIDAR module 112, a phased array radar module 118, a GPS module 120, an accelerometer 124, and a gyroscope 126. The UAV 10 also includes a laser 110 configured to communicate with said sensors to obtain measurements and derive GPS coordinate locations for detected objects.

In some embodiments, the control module 52 includes logic for relaying information between the UAV 10 and GUI 50. This may involve use of the tether 40, a network connection module 142 in the base 30, and communication pathways to the UAV's onboard controller 128. A network uplink 142a may be used to upload environmental or fishing condition data.

In an exemplary embodiment, the system also includes an electronic device in the UAV 10 having a processor 134 and a memory 136. The memory 136 stores instructions which, when executed by the processor 134, perform the same tracking, sensing, displaying, and distance measuring steps described above with respect to the control module 52. The same modes, sub-modes, and GUI functionalities are carried out on the UAV 10 itself to enable autonomous or semi-autonomous drone operation.

In some embodiments, the GUI 50 provides specific interactive locations for initiating data displays and modes. Selecting water depth displays a LIDAR-derived reading 216. Selecting object detection displays radar-derived outputs 220. Selecting HD video feed displays the PTZ camera stream 300. Selecting sub-mode icons, if shown, for Fish-On 250, Family Fun 252, or Man Overboard 262, launches their respective video streams via buttons 352, 386, 376.

The claims herein are further incorporated in the teachings of the detailed specification.

While there has been shown and described above the preferred embodiment of the instant invention it is to be appreciated that the invention may be embodied otherwise than is herein specifically shown and described and that certain changes may be made in the form and arrangement of the parts without departing from the underlying ideas or principles of this invention as set forth in the Claims appended herewith.

I claim:

1. A method for a marine drone system, comprising:
providing a marine drone system including an unmanned aerial vehicle and a control module with screen and graphic user interface, wherein said control module includes a processor configured to execute a program stored on a memory, wherein the memory further includes instructions stored thereon, wherein said instructions, once executed by said processor perform the steps of:
initiating a hover mode of flight;
selecting at least one mode including following mode and sense mode;
obtaining a video feed from a PTZ camera if follow mode is selected, wherein once said video feed is obtained, said mode initiating a tracking function whereby said tracking function will track a watercraft, stream video of said tracking, display said video feed on a display screen of a graphic user interface wherein said follow mode further includes a plurality of tracking sub-modes selectable via the graphic user interface, including: a Fish-On mode configured to lock the UAV camera onto a stern portion of said watercraft and record fishing activity; a Family Fun mode configured to lock the UAV camera onto a designated geographic location and maintain a video stream of said location; and a Man Overboard mode configured to lock the UAV camera onto a detected person in the water and maintain said lock during search and recovery operations; wherein each of said sub-modes is initiated by tapping a corresponding location on said graphic user interface;
providing a list of additional functions if sense mode is selected, including options for monitoring water depth, monitoring objects, and streaming video, wherein said monitoring water depth includes obtaining an output from a LIDAR sensor, said monitoring objects includes obtaining an output from a radar, and said streaming video includes obtaining an output from a PTZ camera;
displaying on a screen of a graphic user interface includes said output from said follow mode and said output from said sense mode;
said displaying on said screen further includes displaying said output from said follow mode or said output mode as an overlay layer with at least one of a map or a camera feed as a background layer;
identifying objects displayed on said screen;
tapping, by way of user interaction, a screen location representing said object; and
selecting, from a list of options, one option thereby executing a sub function of at least labeling said object with an icon, and obtaining a distance of said object or condition, whereby a laser pulses and said distance is calculated from the results of the laser pulse, the beam angle of the laser, and outputs from sensors including a gyroscope, an accelerometer for height, and a GPS for exact location of said UAV, whereby the resulting information is displayed on said screen;
displaying a menu on said graphic user interface that includes interactive locations for:
displaying a video feed;
displaying depth information from a LIDAR output;
selecting at least one of said interactive locations on said graphic user interface;
displaying water depth when said location on said graphic user interface for water depth is tapped;
displaying objects when said location on said graphic user interface for objects is tapped;
displaying an HD video feed when said location on said graphic user interface for HD video feed is tapped;
displaying a live video stream of a stern portion of said watercraft when a location on said graphic user interface for Fish-On Mode is tapped;
displaying a live video stream of a designated geographic location when a location on said graphic user interface for Family Fun Mode is tapped; and
displaying a live video stream of a detected person in water when a location on said graphic user interface for Man Overboard Mode is tapped.

2. The method for a marine drone system, as recited in claim 1, wherein the marine drone system in said step of providing a marine drone system further includes:
a container configured to be mountable on an upper surface of a watercraft, wherein said container further includes a means of supplying power to components of said marine drone system;
an unmanned aerial vehicle; and
a tether coupling said unmanned aerial vehicle to said container.

3. The method for a marine drone system, as recited in claim 2, wherein the tether of the marine drone system in said step of providing a marine drone system includes an electrical supply wiring and data wiring, wherein said tether supplies said unmanned aerial vehicle with power through said electrical supply wiring, and provides for a bi-directional communication link through said data wiring.

4. The method for a marine drone system, as recited in claim 3, wherein the marine drone system in said step of providing a marine drone system further includes:
at least one control module providing an interactive graphic user interface on a display, wherein said control module includes a processor configured to execute a program stored on a memory, wherein said program is configured to:
show a video output;
show a visual radar output;
show a visual LIDAR output;
show a GPS location of said unmanned aerial vehicle;
show a GPS location of said graphic user interface;
said at least one control module including means for relaying information between said unmanned aerial vehicle and said interactive graphic user interface; and
said at least one control module including a network uplink for uploading identification information on fishing conditions.

5. The method for a marine drone system, as recited in claim 4, wherein the unmanned aerial vehicle of said marine drone system in said step of providing a marine drone system further includes:
a weather-proof and water-proof casing;
a plurality of sensors coupled to said unmanned aerial vehicle, including at least one camera, at least one infrared camera, at least one radar module, at least one LIDAR module, and at least one GPS module;
a plurality of propellers capable of lifting said unmanned aerial vehicle and supporting the weight of said unmanned aerial vehicle and a tether; and
a laser, configured to communicate with at least one sensor in said plurality of sensors to obtain information from said sensor, and obtain a GPS coordinate location for objects detected by said at least one sensor and measured by said laser.

6. An electronic device for a marine drone system, comprising:
a processor; and
a memory with instructions stored thereon, wherein said instructions, once executed perform the steps of:
initiating a hover mode of flight;
selecting at least one mode including following mode and sense mode;
obtaining a video feed from a PTZ camera if follow mode is selected, wherein once said video feed is obtained, said mode initiating a tracking function whereby said tracking function will track a preprogramed target, stream video of said tracking, display said video feed on a display screen of a graphic user interface, wherein said follow mode further includes a plurality of tracking sub-modes selectable via the graphic user interface, including: a Fish-On mode configured to lock the UAV camera onto a stern portion of said watercraft and record fishing activity; a Family Fun mode configured to lock the UAV camera onto a designated geographic location and maintain a video stream of said location; and a Man Overboard mode configured to lock the UAV camera onto a detected person in the water and maintain said lock during search and recovery operations; wherein each of said sub-modes is initiated by tapping a corresponding location on said graphic user interface;
providing a list of additional functions if sense mode is selected, including options for monitoring water depth, monitoring objects, and streaming video, wherein said monitoring water depth includes obtaining an output from a LIDAR sensor, said monitoring objects includes obtaining an output from a radar, and said streaming video includes obtaining an output from a PTZ camera;
displaying on a screen of a graphic user interface includes said output from said follow mode and said output from said sense mode;
said displaying on said screen further includes displaying said output from said follow mode or said output mode as an overlay layer with at least one of a map or a camera feed as a background layer;
identifying objects displayed on said screen;
tapping, by way of user interaction, a screen location representing said object; and
selecting, from a list of options, one option thereby executing a sub function of at least labeling said object with an icon, and obtaining a distance of said object or condition, whereby a laser pulses and said distance is calculated from the results of the laser pulse, the beam angle of the laser, and outputs from sensors including a gyroscope, an accelerometer for height, and a GPS for exact location of said UAV, whereby the resulting information is displayed on said screen.

7. A marine drone system, comprising:
a container configured to be mountable on an upper surface of a watercraft, wherein said container further includes a means of supplying power to components of said marine drone system;
an unmanned aerial vehicle;
a tether coupling said unmanned aerial vehicle to a said container; and
at least one control module with screen and graphic user interface, wherein said control module includes a processor configured to execute a program stored on a memory, wherein the memory further includes instructions stored thereon, wherein said instructions, once executed by said processor perform the steps of:
initiating a hover mode of flight;
selecting at least one mode including following mode and sense mode;
obtaining a video feed from a PTZ camera if follow mode is selected, wherein once said video feed is obtained, said mode initiating a tracking function whereby said tracking function will track a watercraft, stream video of said tracking, display said video feed on a display screen of a graphic user interface, wherein said follow mode further includes a plurality of tracking sub-modes selectable via the graphic user interface, including: a Fish-On mode configured to lock the UAV camera onto a stern portion of said watercraft and record fishing activity; a Family Fun mode configured to lock the UAV camera onto a designated geographic location and maintain a video stream of said location; and a Man Overboard mode configured to lock the UAV camera onto a detected person in the water and maintain said lock during search and recovery operations; wherein each of said sub-modes is initiated by tapping a corresponding location on said graphic user interface;
providing a list of additional functions if sense mode is selected, including options for monitoring water depth, monitoring objects, and streaming video, wherein monitoring water depth includes obtaining an output from a LIDAR sensor, said monitoring objects includes obtaining an output from a radar, and said streaming video includes obtaining an output from a PTZ camera;
displaying on a screen of a graphic user interface includes said output from said follow mode and said output from said sense mode;
said displaying on said screen further includes displaying said output from said follow mode or said output mode as an overlay layer with at least one of a map or a camera feed as a background layer;
identifying objects displayed on said screen;
tapping, by way of user interaction, a screen location representing said object; and
selecting, from a list of options, one option thereby executing a sub function of at least labeling said object with an icon, and obtaining a distance of said object or condition, whereby a laser pulses and said distance is calculated from the results of the laser pulse, the beam angle of the laser, and outputs from sensors including a gyroscope, an accelerometer for height, and a GPS for exact location of said UAV, whereby the resulting information is displayed on said screen.

8. The marine drone system, as recited in claim 7, wherein the tether includes an electrical supply wiring and data wiring, wherein said tether supplies said unmanned aerial vehicle with power through said electrical supply wiring, and provides for a bi-directional communication link through said data wiring.

9. The marine drone system, as recited in claim 7, wherein said program is further configured to:
show a visual radar output;
show a visual LIDAR output;
show a GPS location of said unmanned aerial vehicle; and
show a GPS location of said graphic user interface;
said at least one control module including means for relaying information between said unmanned aerial vehicle and said interactive graphic user interface; and
said at least one control module including a network uplink for uploading identification information on environmental conditions.

10. The marine drone system, as recited in claim 7, wherein the unmanned aerial vehicle of said marine drone system further includes:
a weather-proof and water-proof casing;
a plurality of sensors coupled to said unmanned aerial vehicle, including at least one camera, at least one infrared camera, at least one radar module, at least one LIDAR module, and at least one GPS module;
a plurality of propellers capable of lifting said unmanned aerial vehicle and supporting the weight of said unmanned aerial vehicle and a tether; and
a laser, configured to communicate with at least one sensor in said plurality of sensors to obtain information from said sensor, and obtain a GPS coordinate location for objects detected by said at least one sensor and measured by said laser.
